(19) United States
(12) Patent Application Publication
(10) Pub. No.: US 2018/0350000 A1
(43) Pub. Date: Dec. 6, 2018

(54) SYSTEMS AND METHODS FOR GENERATING A GRAPHICAL USER INTERFACE DISPLAYING PARTICIPANT PERFORMANCE INFORMATION

(71) Applicant: Nasdaq Technology AB, Stockholm (SE)

(72) Inventors: Saker ASLLAN, London (GB); Michael O'BRIEN, London (GB)

(21) Appl. No.: 15/994,792

(22) Filed: May 31, 2018

Related U.S. Application Data
(60) Provisional application No. 62/514,451, filed on Jun. 2, 2017.

(51) Int. Cl. G06Q 40/04; G06F 3/0482; G06T 11/20

(52) U.S. Cl. CPC G06Q 40/04; G06T 11/206; G06F 3/0482

(57) ABSTRACT

The technology described herein relates to systems and methods for generating a GUI that can measure performance relative to market data. For example, a GUI can be generated that provides (among other aspects) a visualization that can show trader performance for various financial instruments (e.g., securities) measuring out-performance (or under-performance) relative to market volume weighted average price (or “VWAP”). The GUI can be modified in a variety of ways in order to better understand the data and provide information relevant to a particular user.

### RELATED APPLICATION

This application claims the benefit of priority of U.S. Provisional Application No. 62/514,451 filed Jun. 2, 2017, the entire content of which is incorporated herein by reference.

### TECHNICAL OVERVIEW

The technology described herein relates to a graphical user interface. In particular, the technology described herein relates to generating a user interface that can display information related to participant performance, particularly with respect to participants that exchange one or more tradeable instruments in an electronic market place.

### INTRODUCTION

Technology is available for displaying transaction data using a graphical user interface (or “GUI”) that shows different aspects of one or more transactions. In one example, these GUIs can show transactions in electronic exchange systems where different aspects of the GUI reflect how a trader has performed over a given period of time.

Conventional GUIs for showing such data are useful for conveying a basic idea as to how an entity is performing over a period of time. However, it will be appreciated that new and improved techniques, systems, and processes are continually sought after.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### SUMMARY

The technology described herein addresses the problems in the conventional technology, in part, by providing a system capable of generating a GUI that visually depicts aspects of trader (or account) performance. In particular, the technology described herein relates to systems and methods for generating a GUI that can measure performance relative to market data. After determining the performance relative to market data, a user interface can be generated and displayed showing different aspects of the performance of one or more entities over time.

For example, a GUI can be generated that provides (among other aspects) a visualization that can show trader performance for various financial instruments (e.g., securities) measuring out-performance (or under-performance) relative to market volume weighted average price (or “VWAP”). The GUI can also display performance in a manner allowing for easy detection of abnormalities in trading. The GUI can be modified in a variety of ways in order to better understand the data and provide information relevant to a particular user. The technology allows for more efficient and accurate identification of changes in market data and performance of a trading entity that trades, for example, in an electronic trading system.

This Summary is provided to introduce a selection of concepts in a simplified form that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

FIG. 1 depicts a non-limiting example block diagram of a system;

FIG. 2 shows a non-limiting example block diagram of different software components comprising the system;

FIG. 3 shows a non-limiting example communication process between different devices;

FIGS. 4, 5A, and 5B show non-limiting example flowcharts for processes carried out in the system;

FIGS. 6A-G show non-limiting example user interfaces generated for display; and

FIG. 7 shows a non-limiting example block diagram of hardware components comprising the system shown in FIG. 2.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

### Overview

The technology described herein relates to, among other topics, a system for generating a graphical user interface that conveys information related to performance of an entity (e.g., a trader). In one example, electronic exchange systems allow different entities (e.g., brokers, traders) to conduct exchange of various instruments including security instruments. Once a transaction is initiated by a broker, trader or other entity, the entire series of processes including the matching of buyers and sellers, and the completion of the transaction happens entirely electronically. The computer systems and communication networks that implement these electronic exchange systems enable large numbers (e.g., several hundred thousands to millions) of trades to execute during a trading day. Many of these trades are completed almost instantaneously (e.g., a fraction of a second) upon a buy or sell order being input to the exchange system and/or the input bid or offer prices matching the market price.

The electronic exchange systems can thus maintain database(s) that keep record of these vast amounts of exchanges. The information in these databases can be electronically accessed by the systems in order to generate a GUI that displays a measurement of performance for one or more entities. In one example, the GUI can convey information for measuring out-performance (or under-performance) relative to market volume weight average price (or “VWAP”) of one or more securities.

It should be appreciated that the VWAP is a trading benchmark that is calculated by adding up the dollars traded for each transaction and then dividing by the total shares traded for a particular day. The technology described herein can quantify, up to a value, what the level of out (or under) performance is by measuring performance based on the market VWAP versus the trader/account VWAP. More specifically, the value of performance can be reflected as the difference of market VWAP with trader buy VWAP plus the difference of trader sell VWAP with market VWAP. The determination of performance can be as follows:

performance=(market VWAP−trader buy VWAP)+(trader sell VWAP−market VWAP)

In a sense, out-performance can be measured based on if the trader is buying cheaper than the market and/or selling higher than the market. Likewise, under-performance can be measured based on if the trader is buying higher than the market and/or selling cheaper than the market. The technology described herein is also capable of conveying information in the GUI reflective of “churn” for a particular entity. In one example, “churn” is reflective of a proportion of volume bought and sold on a day (or range of time). For example, if a trader buys 100 shares and sells 100 shares of ABC security, the “churn” value is 100%. Likewise, if the trader buys 100 shares and sells 1 share then the “churn” for that security is 1% (or if the trader sells 200 shares and buys 50 shares the “churn” is 25%).

The technology described herein can generate a GUI that visually depicts the performance of different participants based on the electronic trade data stored in the electronic exchange system. The GUI can be manipulated to show various different types of information including, at least, a comparison among different participants, a participant level view, a security level view, a summary view for a participant, an outlier view, and/or a modification of any of these views across a day or a date range.

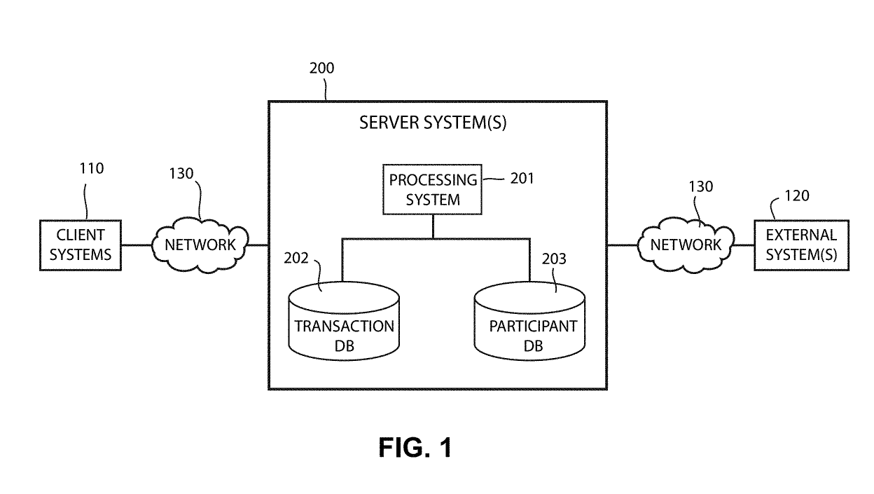

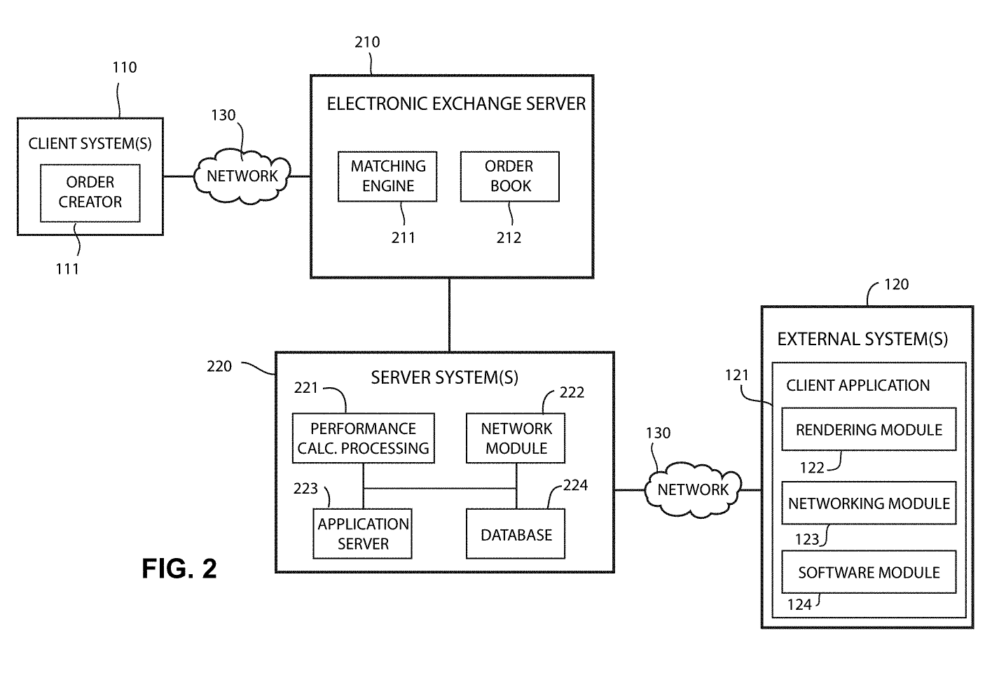

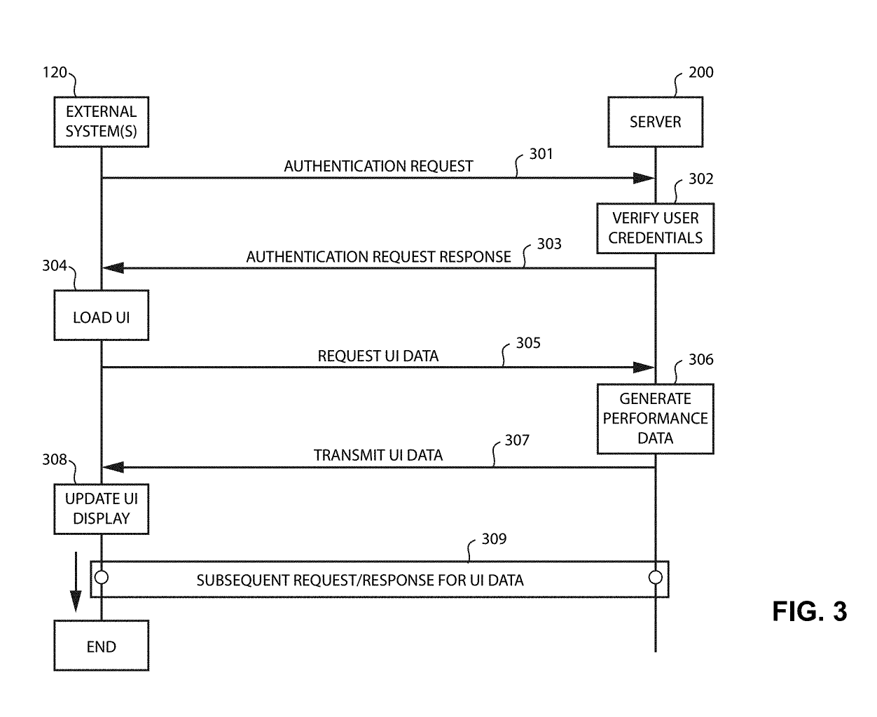

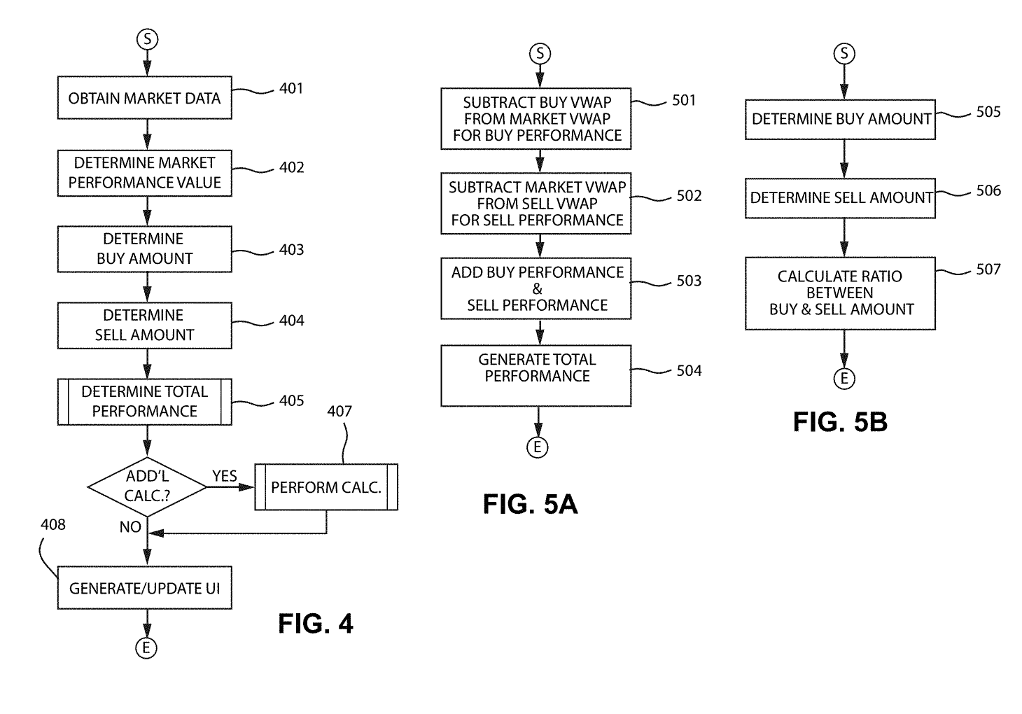

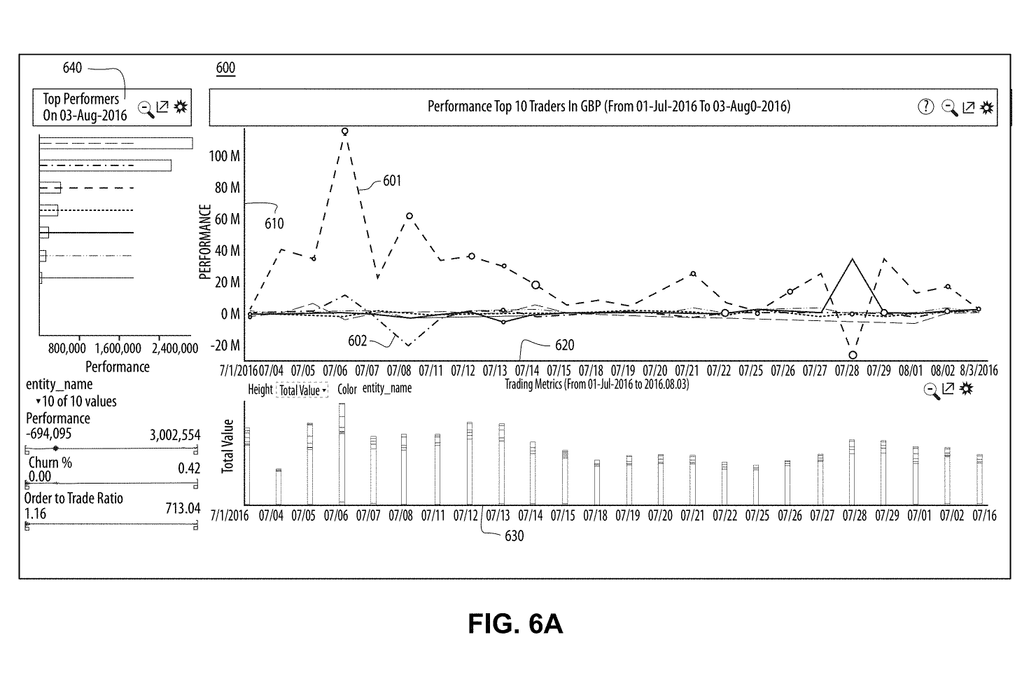

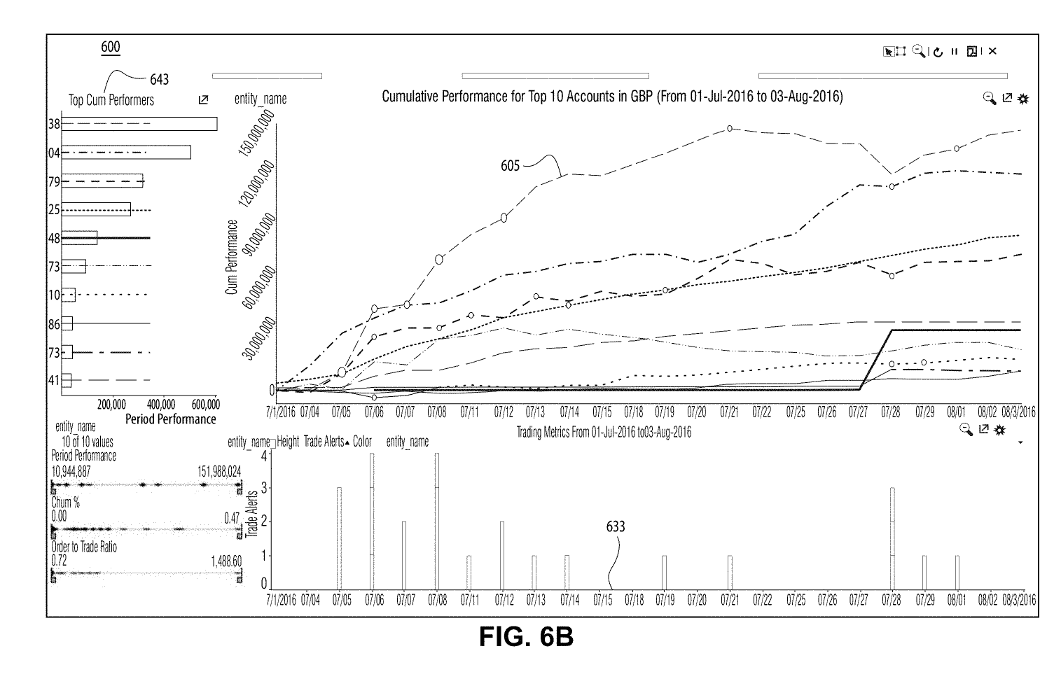

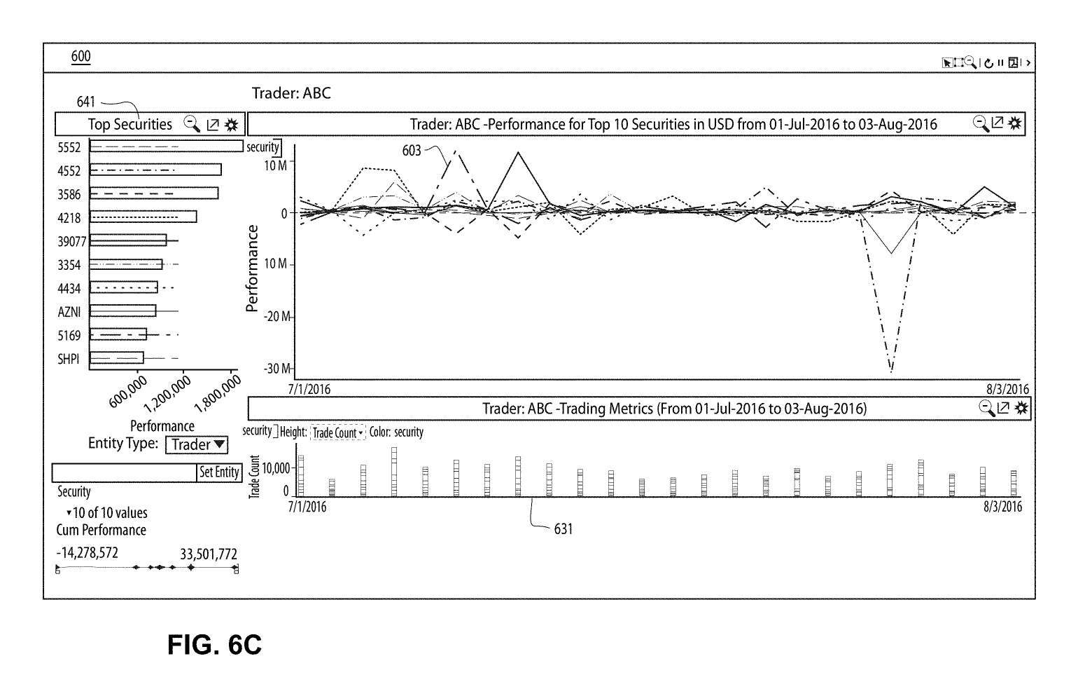

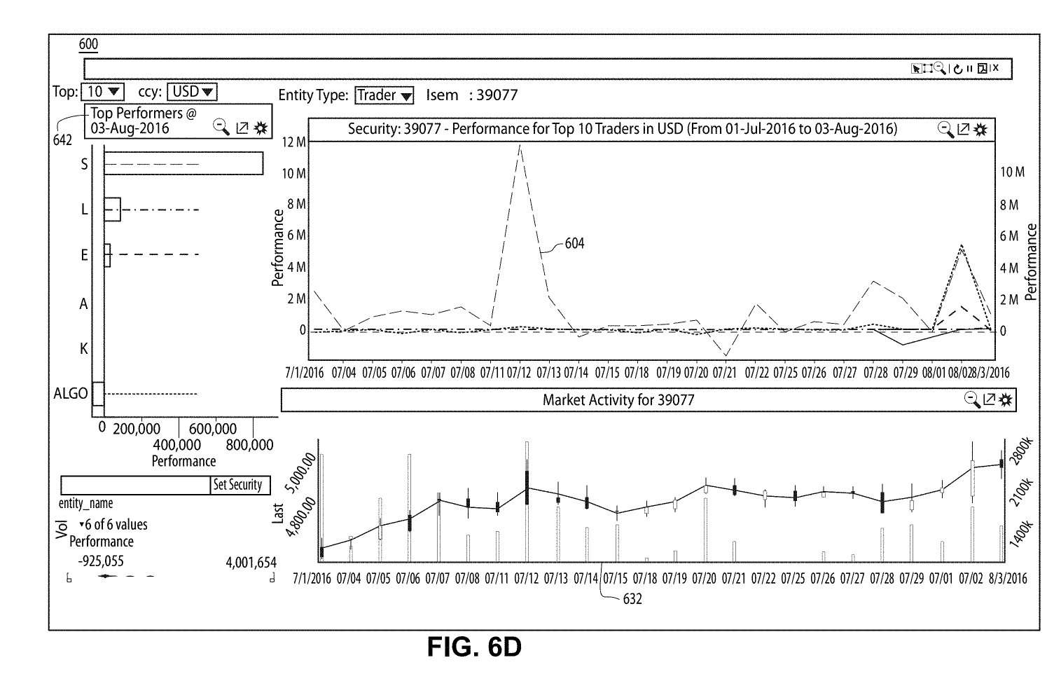

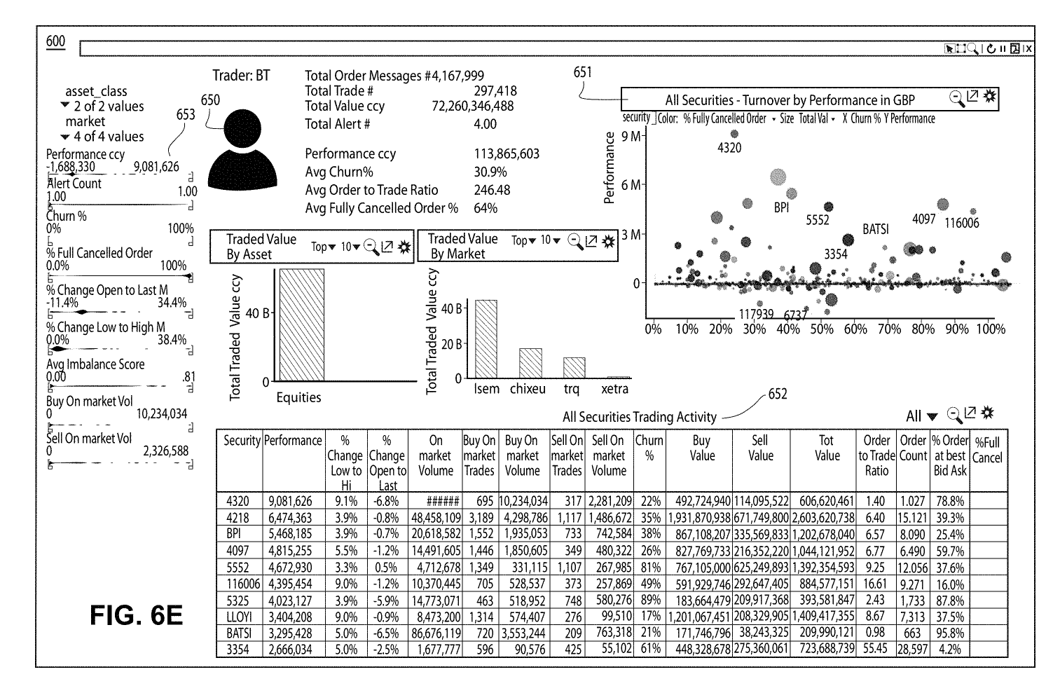

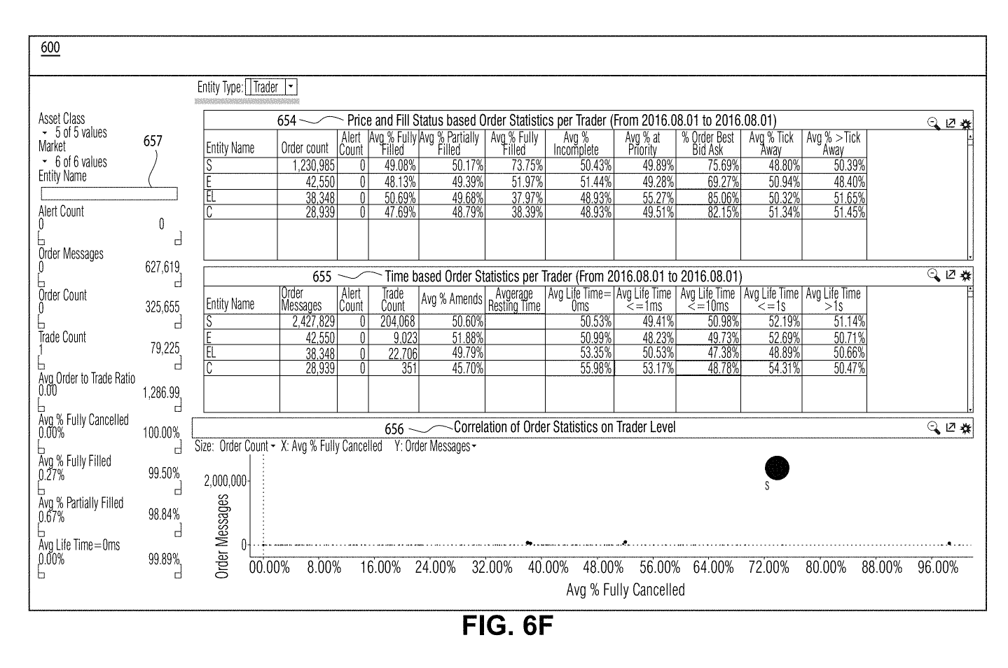

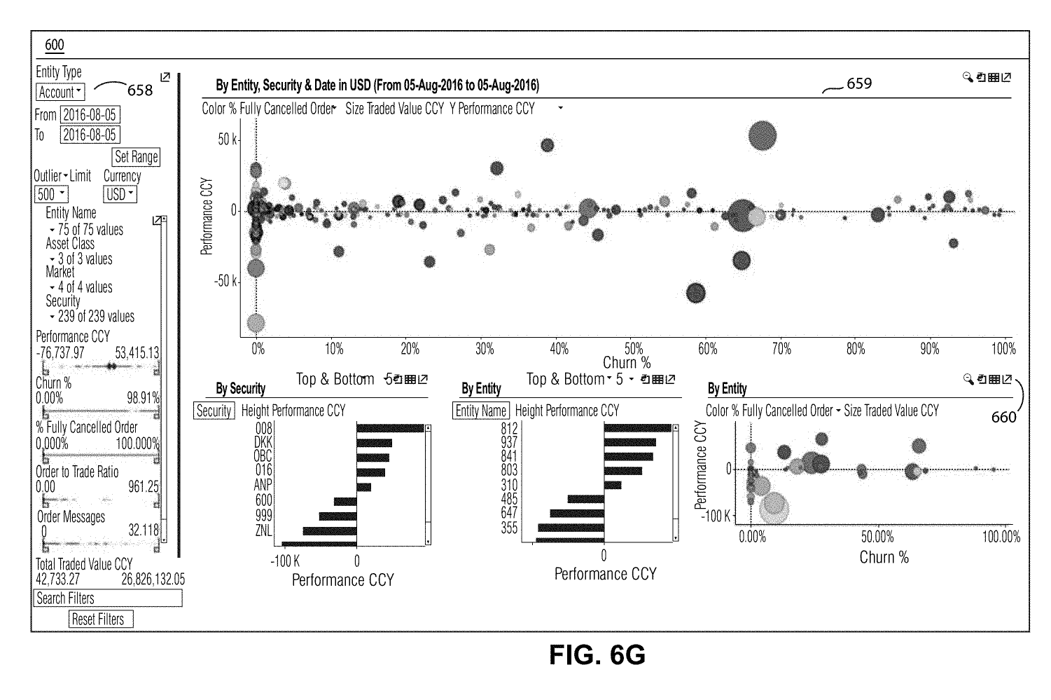

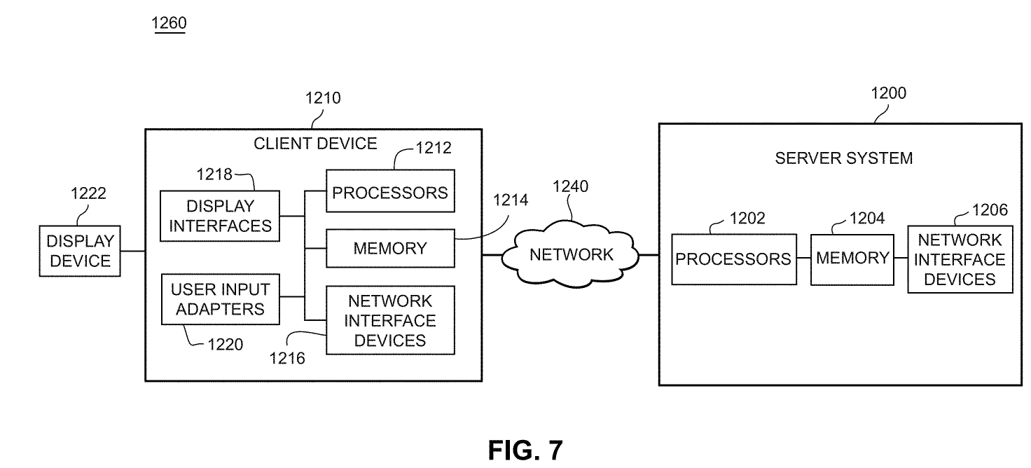

FIG. 1 shows an example system in which orders are processed (e.g., by an electronic exchange system) and trade data is communicated. FIG. 2 shows an example system for generating a user interface that shows performance data, wherein software architecture aspects of the system are highlighted. FIG. 3 shows a communication process between, at least, external system(s) and server system(s) for creating a user interface depicting performance data. FIGS. 4, 5A, and 5B show non-limiting example flowcharts for calculating performance data and generating a user interface. FIGS. 6A-G show non-limiting example user interfaces displaying performance data. FIG. 7 shows an example system in which the features described herein may be implemented, wherein hardware aspects of the system are highlighted.

In many places in this document, software modules and actions performed by software modules are described. This is done for ease of description; it should be understood that, whenever it is described in this document that a software module performs any action, the action is in actuality performed by underlying hardware components (such as a processor and a memory) according to the instructions and data that comprise the software module.

### Description of FIG. 1

FIG. 1 shows a non-limiting example system 200 for analyzing performance information for one or more participants. The system 200 can communicate with one or more client systems 110 via network 130 and can also communicate with one or more external systems 120 via network 130. In one example embodiment, the system 200 could comprise a server (or a collection of server) system(s) that can process transaction data associated with one or more order data entry messages sent from client system(s) 110. The client system(s) 110 could include one or more computers operated by an entity such as, for example, a broker that enables entities such as individuals and/or corporations to trade various tradeable instruments. A tradeable instrument may be, for example, a financial instrument such as a stock, bond, option, or other security etc.

The server system 200 has at least a processing system 201 that can process various data within the system 200 and received from various devices (e.g., client system(s) 110, external system(s) 120). For example, the processing system 201 can process transaction data received from client system(s) 110 and store the transaction data information into transaction database 202. In one example embodiment, the system 200 could receive order data messages from client system(s) 110 and attempt to match the orders in order data messages with other orders stored in an order book of the system 200. Information associated with these transactions can then be stored in transaction database 202.

Processing system 201 can also use data found in transaction database 202 to generate data for a user interface. In one example embodiment, processing system 201 will calculate performance information for one or more participants and store the performance data in a participant database 203. This performance data could relate to, for example, how different participants are performing relative to market data for one or more securities traded via the system 200. The processing system 200 can then communicate the performance data to various external system(s) 120 via network 130. It should be appreciated that the client system(s) 110, server system(s) 200, and/or external system(s) 120 will employ a variety of communication circuitry, as well as processing circuitry that includes input/output devices, data transceivers (for transmission of digital and/or analog signals), one or more processors (e.g., a CPU), one or more storage devices (e.g., a memory), and/or one or more audio/visual components (e.g., sound interface, display).

### Description of FIG. 2

FIG. 2 shows a non-limiting example diagram of a system 200 wherein the framework for processing performance data and generating a user interface can be implemented. As will be described below, one or more applications that implement the framework for processing performance data and generating the user interface can be deployed in the system 200, and the various components in the system 200 (such as the client system(s) 110, electronic exchange server 210, application program interface (API) server 220, and/or external system(s) 120) can perform different functions related to the deployed applications.

As will be discussed below, FIG. 2 shows primarily software modules (such as the software module 124 running on client application) that run at the external system(s) 120, electronic exchange server 210, API server 220, and the client system(s) 110; it should be understood that the software modules shown in FIG. 2 are stored in and executed by hardware components (such as processors and memories); details regarding example hardware components that may be used to execute these software modules are provided below with reference to FIG. 7, as well as in other places in this document.

One or more client system(s) 110 can be configured to generate order data messages using an order creator 111 stored on each respective system. In one example embodiment, order creator 111 can enable clients (e.g., corporations, individuals, etc.) to input information for the trading of one or more financial instruments. The order creator 111 then operates to generate corresponding orders which can be transmitted to the electronic exchange server 210 via network 130. It should be appreciated that an order is an electronic record representing an instruction to trade/buy/sell a particular quantity of a tradeable instrument. An order may have respective data fields and may also include other instruction messages such as, for example, instructions to amend an already submitted order or to delete an already submitted order.

The electronic exchange server 210 can receive the order data messages from client system(s) 110 where the orders received can be entered into an electronic order book 212. The electronic order book 212 is a data structure that keeps track of received orders and their progress. Buy orders from the received orders are entered into the buy side of the order book, and the sell orders are entered into the sell side of the electronic order book. The order book may also be updated in accordance with received order amend or order delete messages. A matching engine 211 operates to match each buy order in the electronic order book 212 with one or more sell orders recorded in the electronic order book 212. Various known techniques can be used in finding optimal matches.

The electronic exchange server 210 can be operatively associated with an API server 220 for generating a user interface related to performance data. In one example, the API server 220 can access the electronic exchange server 210 to extract information related to different orders and transactions associated with one or more accounts in relation to one or more tradeable instruments. In certain examples, each order and/or transaction that is stored with electronic exchange server 210 (or on another server) is associated with a user or participant identifier that is used to identify the corresponding user, participant, or other entity that is associated with the trade or order. For example, API server 220 can extract transaction information for one or more securities that are bought or sold by one or more users and utilize the information for determining performance of a participant with respect to each security. In one example embodiment, a performance calculation processing module 221 can use the information received from electronic exchange server 210 to calculate performance of a participant with respect to a given security using market data, buy, and sell data for the security. This performance data can be stored in database 224 of the API server 220. The database 224 may be or include one or more of: a relational database management system (RDBMS); an object-oriented database management system (OODBMS); an object-relational database management system (ORDBMS); a not-only structured query language (NoSQL) data store; an object cache; a distributed file system; a data cluster (based on technology such as Hadoop); and/or any other appropriate type of data storage system).

The electronic exchange server 210 and API server 220 are configured to communicate with the client system(s) 110 and/or external system(s) 120 (e.g., via a network 130). It should be appreciated that the network 130 could comprise a network of interconnected computing devices, such as the Internet. The network 130 could also comprise a local area network (LAN) or could comprise a peer-to-peer connection between the different devices in the system 200. The electronic exchange server 210 and API server 220 could comprise any variety of server devices including, but not limited to, database servers, file servers, web servers, application servers, a server cluster (e.g., a cloud based computing environment), a standalone server, and/or any other portable or stationary computing device having server-based capabilities. It should be appreciated that the electronic exchange server 210 and API server 220 can be implemented using separately located hardware (e.g., remote hardware) or can be implemented using a same piece of hardware (e.g., within a single housed server device).

The API server 220 can further include an application server 223 that can, for example, execute server-side (or “back end”) instructions for applications that run on the server system 200. The API server 220 can further include a network module 222 that can communicate with, at least, the external system(s) 120 via network 130.

The external system(s) 120 can include software components for performing processing related to applications deployed in the system 200. As a non-limiting example, the external system(s) 120 may have a client application 121 consisting of, at least, a rendering module 122, a networking module 123 and a software module 124. Of course, these modules are a non-limiting example, and the application 121 can comprise several more modules and/or different modules than those shown in FIG. 2. The external system(s) 120 could comprise any variety of client-based devices including, but not limited to, a personal computer (e.g., a desktop computer, a laptop computer), a thin client, a hybrid client, a rich client, a game console, a tablet, a personal digital assistant (PDA), a smartphone, a digital music player having web interface capabilities, and/or any other portable or stationary computing device.

The rendering module 122 in the external system(s) 120 can implement functionality for the graphical display and rendering of user interfaces. It can, for example, generate graphical data that corresponds to an image class that represents graphical images processed by the client application 121; this graphical data can, potentially after further modification/transformation by the operating system of the external system(s) 120, be displayed on a display of the system(s) 120. Alternatively or additionally, whenever it is described in this document that the external system(s) 120 renders/displays image data, the rendering/displaying module 122 may perform functionality related to the rendering/display of the image data.

The networking module 123 can implement a communication protocol, and be used to handle various data messages between the external system(s) 120 and, at least, the API server 220 in the server system 200. In one non-limiting example, the networking module 123 may carry out a socket connection by using a software connection class to initiate the socket connection between devices. Once the sockets are connected, networking module 123 may transfer data to/from the API server 220 (e.g., via API server's network module 222).

The software module 124 can be used to execute various code loaded at the client application 121, and perform other functionality related to the software. The software module 124 may be, for example, a Java runtime engine or any other type of software module capable of executing computer instructions developed using the Java programming language. This example is of course non-limiting and the software module 124 may execute computer instructions developed using any variety of programming languages including, but not limited to, C, C++, C#, Python, JavaScript, or PHP. Alternatively or additionally, whenever it is described in this document that the external system(s) 120 performs functionality related to the software module, such functionality may be handled by the software module 124.

It should be appreciated that the components shown in FIG. 2 can be implemented within a single system. The components could also be incorporated in multiple systems and/or a distributed computing environment (e.g., a cloud computing environment). Thus, the system 200 is not limited to a single component and can be incorporated into multiple components.

### Description of FIG. 3

FIG. 3 shows a non-limiting communication process between external system(s) 120 and server system 200. FIG. 3 relates to an example client application that uses the described interface generated in the performance analysis system. Although not shown in FIG. 3, the external system(s) 120 may run the client application 121 shown in FIG. 2, and described above, and the server 200 may run software modules such as the application server 223, database 224, network module 222, and performance calculation processing module 221.

In one example embodiment, the client application 121 could be pre-installed on the external system(s) 120, obtained via network 130 from the server system 200 (or any other data source), and/or could be distributed between the external system(s) 120 and any other remote devices. The client application 121 may be embodied as a desktop application, but could also be embodied as any other variety of application, including as a web application. It should be appreciated that the client application 121 may be accessed by a user of the external system(s) 120 who can “open” the application for execution.

In one non-limiting example, opening the application may entail the application establishing an initial communication session with server 200. Upon beginning execution of application 121, at action 301, the external system(s) 120 may send an authentication request 301 to server 200. For example, application 121 may provide a prompt for a user to enter a username and password in order to have the application 121 open a connection with the software modules executed by server 200.

At action 302, the server 200 may verify the user credentials transmitted from system(s) 120. In one example, the server 200 may attempt to reconcile the transmitted username and password with a username/password combination stored in a memory of the server 200. Upon verifying the user credentials, the server 200 will, at action 303, send an authentication request response indicating that the user is verified to access the system resources of server 200 using the client application 121. Alternatively, if the server 200 cannot verify the user credentials, the server 200 may deny user access in the response sent at action 303.

Upon successful authentication from server 200, the external system(s) 120, at action 304, can load the user interface for displaying information related to the mentioned performance data. In one non-limiting example, the external system(s) 120 will generate a display (shown on a display device) comprising the loaded user interface and, at action 305, can request data from server 200 to populate different portions of the user interface. In one non-limiting example, the external system(s) 120 will generate a display related to performance data for one or more traders on a given day. As an example, the user interface may begin populating data related to how a trader performed with respect to one or more securities.

As the external system(s) 120 may not store specific details regarding the performance data for different participants, the external system(s) 120, at action 305, will request data for populating aspects of the user interface, particularly related to the performance data. For example, the client application 121 may be attempting to populate the user interface to show how a given number of participants (e.g., ten) performed for a type of security at the end of a specific trading day. The client application 121 may transmit a query request to server 200 (at action 305) containing information identifying a type of security, a date (or date range), and/or a number of participants (e.g., number of “top” traders).

At action 306, the server 200 can generate the performance data associated with the received query/request. In one example embodiment, the server 200 may already have pre-calculated the performance value for each security traded by individual participants. In another example embodiment, the server 200 may calculate the performance value for each security in real-time based on the information requested in the query. In either case, the server 200 can determine the performance value for each security using the equation: performance=(market VWAP−trader buy VWAP)+(trader sell VWAP−market VWAP). Upon calculating the performance values (as well as any other values for display in the user interface), the server 200 (at action 307) will transmit the user interface response data to external system(s) 120.

Upon receiving the response data, the client application 121 on system(s) 120 will generate and/or update the user interface display, at action 308, to reflect the received data. In one example, the user interface may generate a graph showing performance metrics between different traders for one or more securities. The user interface may display a variety of additional information that is shown, for example, in FIGS. 6A-G discussed in further detail below.

The client application 121 may further update (either automatically or via user manipulation) the display and execute subsequent requests for data from server 200 (at action 309). It should be appreciated that, at least, actions 304-308 may be repeated multiple times as the user and/or application 121 update the user interface at action 309. Although actions 301-309 are shown in FIG. 3 as occurring once, these actions 301-309 may, in various embodiments, be repeated a number of times during the loading of a particular display in the user interface of client application 121.

### Description of FIG. 4

FIG. 4 shows a non-limiting example method that may be performed by server system 200 for processing performance data and generating a user interface. As the method of FIG. 4 begins, the system 200 will obtain market data (at action 401) related to different securities and participants that buy/sell the securities. In one example, the system 200 may access the transaction database 202 to obtain information related to different trades associated with a type of security and the different participants (e.g., traders or accounts) that bought/sold the security for a given day (or date range).

At action 402, the system 200 can calculate a market performance value associated with a particular security. For example, a user may want to know how different participants fared with respect to the market on a particular day for security “ABC.” The system 200 could first determine the market VWAP for the “ABC” security on the given day.

At action 403, the system 200 could determine the participant buy VWAP for a security on a given day. In one non-limiting example, the participant buy VWAP could reflect the participant's volume weighted average price for a security the participant bought on the day in question.

At action 404, the system 200 could further determine the participant sell VWAP for a security on a particular day. In one non-limiting example, the participant sell VWAP could reflect the participant's volume weighted average price for the security sold on the day in question. Using the information obtained at actions 402-404, the system 200 can determine the total performance value for a trader on a particular security for a given day at action 405.

At action 406, the system 200 may determine if further calculations are required in relation to participant performance. For example, the system 200 may also want to calculate additional information including “churn” amount for a given security, a cumulative performance amount for a trader on a given security, or any other additional value the system 200 may attempt to calculate. If additional calculations are required, the system 200 will perform these calculations at action 407. Otherwise, the system 200 can generate and transmit information that will be reflected on the user interface of external system(s) 120 (at action 408).

Such user interfaces may be generated and displayed, in some embodiments, as described in more detail below. It should be understood that, although actions 401-408 are described above as separate actions with a given order, this is done for ease of description. It should be understood that, in various embodiments, the above-mentioned actions may be performed in various orders; alternatively or additionally, portions of the above-described actions 401-408 may be interleaved and/or performed concurrently with portions of the other actions 401-408.

### Description of FIGS. 5A & 5B

FIGS. 5A and 5B show further non-limiting example methods carried out by system 200. FIG. 5A shows a non-limiting example method providing further details of determining the total performance value (as discussed with respect to action 405, above). The system 200 begins, at action 501, by first subtracting the participant buy VWAP for a given security from the market VWAP for the security to determine a “buy performance value.” It should be appreciated that if the market VWAP for the security is greater than the participant buy VWAP, then the “buy performance value” will reflect that the participant bought cheaper than the market value. Conversely, if the market VWAP for the security is less than the participant buy VWAP, then the “buy performance value” will reflect that the participant bought higher than the market value.

At action 502, the system 200 can subtract the market VWAP for a given security from the participant sell VWAP for the security to determine a “sell performance value.” It should be appreciated that if the participant sell VWAP is higher than the market VWAP for the security, then the “sell performance value” will reflect that the participant sold higher than the market value. Conversely, if the participant sell VWAP is lower than the market VWAP for the security, then the “sell performance value” will reflect that the participant sold cheaper than the market value.

At action 503, the system can add the “buy performance value” with the “sell performance value” to determine the total performance value (at action 504) for a given security for each trader. As an illustrative example for determining the performance, the system may determine that the market VWAP for security “ABC” is $1.00. If participant 1 buys 100 shares at $0.50 then the value of their outperformance is $5. Likewise, if participant 1 sells 100 shares at $1.50, then the value of their outperformance is $5. Thus, the total performance value (reflecting outperformance) for participant 1 for security “ABC” at the given date would be $10 (i.e., $5 “sell performance value”+$5 “buy performance value”). Conversely, if participant 1 buys 100 shares at $1.50 and sells 100 shares at $0.50, then the total participant value of their underperformance is $10. It should be appreciated that system 200 can perform these calculations across millions of transactions occurring at the system 200 and such information can be stored in a memory and later accessed by system 200.

It should be appreciated that the examples described above are non-limiting, and the technology envisions a variety of methods for determining performance. For example, the system 200 can assign basis points to show relative performance per unit, as measure of how one entity outperforms the market per traded unit of a security. A non-limiting formula for calculating the relative performance is discussed in greater detail below (see e.g., “Relative Performance Per Unit BPS” in discussion of “Participant 360” dashboard). In one non-limiting example, the scenario where the user has a performance value of $10 as discussed above may be assigned a value of relative performance per unit in “basis points.” In the example above, the entity would receive 5,493 basis points for the performance value of $10 reflective of the relative performance per unit for the given security. To further illustrate, the entity may also purchase security “ABC” (in which the market VWAP is also $1.00) where the entity buys 1000 units at $0.50 (having a buy side outperformance of $500). Likewise the entity may sell 1000 units at $1.50 (having a sell side outperformance of $500) with a total performance value of $1,000. In this case, the system 200 would still assign 5,493 basis points reflective of the performance per unit for the given security. These examples are of course non-limiting and the technology described herein envisions a variety of methods for calculating performance.

FIG. 5B shows a non-limiting example method providing further details for determining at least one additional calculation the system 200 is configured to process. In one non-limiting example, the system 200 may calculate the “churn” amount (e.g., “churn” percentage) representing a proportion of volume bought and sold on a day (or date range/period).

At action 505, the system 200 can determine a buy amount of a given security for each individual participant. For example, the system 200 may determine how many shares a participant purchased of “ABC” stock. At action 506, the system 200 can determine a sell amount of the given security for each individual participant. For example, the system 200 may determine how many shares a participant sold of “ABC” stock.

At action 507, the system 200 can calculate the ratio (or percentage) between the buy amount and sell amount of a given security. In one non-limiting example, the “churn” value can be represented as a percentage using the formula: churn=(buy amount/sell amount)×100 (when buy amount is less than sell amount) or churn=(sell amount/buy amount)×100 (when sell amount is less than buy amount).

As an illustrative example, if participant 1 buys 100 shares of ABC stock and sells 100 shares of ABC stock, the calculated “churn” value is 100%. If participant 1 buys 100 shares of ABC stock and sells 1 share of ABC stock, the calculated “churn” value is 1%. If participant 1 sells 200 shares of ABC stock and buys 50 shares of ABC stock, the calculated “churn” value is 25%. It should be appreciated that a participant could be a trader or account. Of course, the technology described herein envisions the participant to be any other type of entity as well and is not limited to just a trader or account. Additional discussion with respect to calculating churn is discussed in further detail below.

The system 200 is also capable of determining of various trading metrics. For example, the system 200 may also determine an order to trade ratio, a total traded value, a total traded volume, a percentage of fully canceled orders, and/or a percentage of orders at best bid/ask price/amount. These examples are of course non-limiting and the technology described herein envisions a variety of trading metrics that can be calculated and displayed via the user interface.

In one non-limiting example, the technology described herein can be used to show various aspects related to account performance (among other aspects). The technology can help identify traders/accounts that are more “risky” through identification of anomalous trading attributes relative to peers and/or benchmark/average. The technology focuses on identifying relative performance of each trader/account compared to the market particularly where an entity generates extraordinary out-performance from its trading over a short period, consistent positive out-performance over an extended period, or out-performance which consistently exceeds peer traders. Higher than normal performance may be indicative of higher risk and/or manipulative trading.

The system 200 (and particularly the user interfaces) provide for review of all trading activity details for a given trader/account. In one example embodiment, the technology enables “drilling” (or “zooming”) capabilities that allow the user to “drill” up or down various aspects of the user interface. For example, the user interface provides different views such as a “participant zoom,” “participant 360,” or a “security zoom” (among other views) in which the user can switch between the views through zoom/drill operations. In doing so, the technology enables “interrogation” of different trading data metrics (i.e., real time ad hoc query with filtering capabilities that generate interactive dashboards), identification of outlier participants, and ability to adjust filters to identify risks in trading data. The details of such features are further described with respect to the various user interfaces shown in the figures, and discussed in further detail below.

### Description of FIGS. 6A-G

FIGS. 6A-G show non-limiting example user interfaces that can be displayed on a display device (e.g., a display device operatively coupled to external system(s) 120). In one non-limiting example, the user interfaces can convey data relating to market performance of different participants with respect to one or more tradeable instruments (e.g., securities). FIGS. 6A-G are also representative of different displays that can be generated as a user “drills down” into various data shown on each individual display. That is, the user interface is configured to enable users to drill down to show one or more different views associated with the user interface.

FIG. 6A shows a non-limiting example user interface 600 showing a comparison of multiple participants over a period of time (e.g., a “Participant Comparison” dashboard). The user interface of FIG. 6A is configured to display a comprehensive, aggregated view of a participant's trading performance based on the trading periods and markets of interest to the user. For example, the user can use this dashboard in at least three ways: (1) a “Comparison Graph” that provides the user with a graphical representation of the performance of the chosen number of top entities over the defined date range; (2) the user can make a direct comparison between the performance of top entities on the last day of the investigated time period; and (3) a bar chart titled “Trading Metrics” summarizes daily trading statistics for the chosen number of top entities over the defined date range, such as, Delete Count, Trade Count and Total Alert Count, which can be aggregated across all trading securities for each entity in a specific asset class. Each graph on the user interface can aggregate all securities across all markets by asset class for each entity on a specific date. It should be appreciated that the user interface can enable detection of a specific account that significantly out-performs the market (as well as other peers) which can be indicative of suspicious trading activity, for example.

In one non-limiting example, the user interface can display a graph portion where the graph contains a first axis 610 representative of a performance value and a second axis 620 representative of a time value. In one non-limiting example, the performance value shown along the first axis 610 can correspond to a dollar amount associated with a number of shares sold for a tradeable instrument multiplied by a share price for each tradeable instrument. The time value shown along the second axis 620 can correspond to a date (or date range) in which the performance data is related. These examples are of course non-limiting and the technology described herein envisions a variety of different values that can be shown along the first axis 610 and/or second axis 620.

In one non-limiting example, the graph can comprise a line graph where each participant's performance is representative by an individual line. For example, the graph can show a first participant 601 in comparison to a second participant 602 by displaying each participant as a line in the line graph. Each point in the graph for each participant could represent how the participant performed on a given day where the size of each point (e.g., circle) can represent the number of alerts for a participant on a given day. In one example, the alert could be representative of information indicating that the participant performed in a manner that should be further investigated. In the example shown in FIG. 6A, participant 601 appears to significantly outperform other participants at various points and thus alerts may be generated at those points to indicate that the reasons for the participant's performance may need to be further investigated. The user interface may contain other information for display when the user interacts with various portions of the user interface. For example, additional information can be displayed as a “pop-up” when a mouse hovers over a participant performance point. The pop-up may include information such as average churn percentage, total traded value, average order to trade ratio, a number of alerts, a performance value, and a date. It should also be appreciated that each line representing a participant may be assigned a particular color, where each participant's point is colored according to the assigned color and the lines between the points are then connected. The example shown in FIG. 6A (as well as the other figures showing the user interface) may show dotted/broken lines in various portions. However, these dotted/broken lines are for illustrative purposes to represent different accounts/entities and may not be displayed on the actual user interface.

It should be appreciated that various parameters may need to be set for loading the graphs and filters shown in the user interface for the “Participant Comparison.” These parameters and/or filters can be accessible in the portion of the interface containing the top performer area 640. In one non-limiting example, one parameter may include an entity type which can be defined as either an “account” or “trader” where another parameter may include an asset class that classifies the trading security type (e.g., an equity). Another parameter may include a date range which relates to the time period covered in this view of the user interface, while another parameter may be a top parameter indicative a number of top performing participants (e.g., to be investigated). Yet another parameter could include a currency value indicate of the type of currency used in calculating the results displayed. The system can select any variety of currency including, at least, AUD, CAD, EUR, GBP, HKD, JPY, SGD, and USD. The currency value used in the conversion can be the midpoint price of the best bid and best ask at 4 PM (GMT) on a selected date. Another parameter could include a set mode parameter related to the type of mode displayable in the graph (e.g., daily, cumulative). If a daily mode is selected, the user interface may display a summary view of top performing participants selected based on their performance on the last trade date. If a cumulative mode is selected, the user interface may display a summary view of the top performing participants selected based on their cumulative performance over a defined date range. The user interface may also use various filters including, but not limited to, a market filter which lists markets traded by top participants in a selected asset class. Another filter may be an entity name filter which filters a list of entities that are top participants.

The user interface 600 may also include a trading metric area 630 showing a value of a participant on a given day. In one example, each day could include a bar graph where the participant's proportion of value for the day may be represented by how much their associated color is shown in the graph. For example, the percentage of color in the bar graph for a given participant may reflect how that participant performed relative to the other participant colors. The bar graph may display daily trading statistics for a chosen number of top entities over a defined date range where the values can be aggregated across all trading securities for each entity. A pop-up window may be displayed via a mouse hover event that can display information including, but not limited to, trade count, order count, delete count, amend count, and total value. Moreover, the user interface may also provide a drop-down button that allows the visualization to be changed to accommodate a user's preferred metrics (e.g., order count, buy value, sell value, number of alerts). A list of such metrics with associated data elements, descriptions, and formulas is as follows:

Buy Value: daily total buy trading value of each entity, for all securities across all markets by asset class converted to the chosen currency.

Buy Value=Σᵢ₌₁^{all} (Entity Buy VWAP_Securityᵢ*Buy On Market Volume_Securityᵢ) of an entity

Sell Value: daily total sell trading value of each entity, for all securities across all markets by asset class converted to the chosen currency.

Sell Value=Σᵢ₌₁^{all} (Entity Sell VWAP_Securityᵢ*Sell On Market Volume_Securityᵢ) of an entity

Net Value: difference between the Buy Value and the Sell Value.

Net Value=Buy Value−Sell Value

Order Count: daily total number of enter orders submitted per entity for all securities across all markets by asset class.

Order Count=Σᵢ₌₁^{all} Enter Orders_Securityᵢ (of an entity)

Delete Count: daily total number of delete orders submitted per entity for all securities across all markets by asset class.

Delete Count=Σᵢ₌₁^{all} Delete Orders_Securityᵢ (of an entity)

Amend Count: daily total number of orders amended per entity for all securities across all markets by asset class.

Amend Count=Σᵢ₌₁^{all} Amend Orders_Securityᵢ (of an entity)

Trade Count: daily total number of on-market trades executed per entity for all securities across all markets for the selected asset class.

Trade Count=Σᵢ₌₁^{all} BuyTrades_Securityᵢ+Σᵢ₌₁^{all} SellTrades_Securityᵢ (of an entity)

Buy Trade Count: daily total number of on-market buy trades executed per entity for all securities across all markets by asset class.

Buy Trade Count=Σᵢ₌₁^{all} BuyTrades_Securityᵢ (of an entity)

Sell Trade Count: daily total number of on-market sell trades executed per entity for all securities across all markets by asset class.

$$Sell Trade Count = {\sum }_{i = 1}^{all} {SellTrades\_Security}_{i}$$

Performance: an entity's daily performance relative to the market performance across all securities and all markets by asset class converted to the chosen currency. This metric examines the performance of entities in terms of their security selection and timing of their order(s) against the benchmark (which can be the market VWAP).

$${Performance\_Security}_{i} = ( Market VWAP - Entity Buy VWAP ) * Entity Buy On \text{-} Market {Volume\_Security}_{i} + ( Entity Sell VWAP - Market VWAP ) * Entity Sell On \text{-} Market {Volume\_Security}_{i} Performance\_All Securities for an entity = {\sum }_{i = 1}^{all} {Performance\_Security}_{i} by market and asset class$$

Total Value: total traded value of each entity per day across all securities across all markets by asset class converted to the chosen currency.

Total Value=Σᵢ₌₁^{all} Traded Value_Securityᵢ (of an entity)

Alerts: total number of primary alerts triggered at trader or account level over the chosen trading dates for all securities across all markets plus EComm Alerts (described below).

Alerts=Σᵢ₌₁^{all} TradeAlerts_Marketᵢ+ΣEcommAlerts (of an entity on a specific day)

Trade Alerts: total number of trade alerts generated by a specific entity on a specific date across all markets.

$$Trade Alerts = {\sum }_{i = 1}^{all} {TradeAlerts\_Market}_{i} ( of an entity on a specific day )$$

EComm Alerts: total number of alerts provided by the client via a daily upload for a specific entity on a specific date across all communication channels.

$$Ec EComm Alerts = {\sum }_{i = 1}^{all} {ECommAlerts\_Channel}_{i} ( of an entity on a specific day )$$

The user interface 600 may also show a top performer area 640. In one example, the top performer area 640 may show a bar graph similar to that shown in trading metric area 630, but each individual bar graph may only pertain to a performance of each participant as of a last trade date. The top performer area 640 can further provide direct comparison between performance of top entities on a last day of a particular time period, where, in the example of the bar graph, each bar can represent a different entity identified by account/trader name. The top performer area 640 may also include options for setting the parameters and filters, discussed in detail above.

FIG. 6B shows another aspect of the non-limiting example user interface 600. In one non-limiting example, the display shown in FIG. 6B can correspond to a “cumulative comparison” indicative of cumulative performance over a period of time. In particular, FIG. 6B can be representative of another “Participant Comparison” display but showing the cumulative performance in this view.

The display shown in user interface 600 can include a bar graph where each line in the bar graph can represent cumulative performance of a participant over one or more tradeable instruments. The graph could include participant 605 represented as a line in a line graph where the line depicts the participant 605 cumulative performance for one or more securities over time. That is, each line for participant 605 could have multiple points where each point represents the participant's performance for one or more securities and each participant may be assigned a specific color. The lines connecting each point can also be represented with the same color for the participant thereby conveying how that participant performed for one or more securities over time.

The user interface 600 can also include a trading metrics area 633. Similar to trading metrics area 630, the area 633 can include a bar graph showing a cumulative value of one or more tradeable instruments on a given day. In one example, each day could include a bar graph where the one or more instruments proportion of cumulative value for the day may be represented by how much their associated color is shown in the graph. For example, the percentage of color in the bar graph for a one or more instruments may reflect how the instrument(s) performed relative to the other instrument(s) colors. The user interface 600 may also show a top cumulative performer area 643. In one example, the top cumulative performer area 643 may show a bar graph similar to that shown in trading metric area 630, but each individual bar graph may only pertain to a cumulative performance of one or more tradeable instruments (for a participant) as of a last trade date. It should be appreciated that the cumulative mode can highlight top participants accumulated performance over a period of time (i.e., rather than performance on a last trade date). Moreover, the techniques used in the cumulative mode may also be used for the “Participant Zoom” dashboard, discussed in further detail below.

FIG. 6C shows another aspect of the non-limiting example user interface 600 illustrating further details related to performance of an individual participant. In one example, the display shown in FIG. 6C can correspond to a “drill down” feature for a “Participant Zoom” that can include a graph indicative of how a participant performed for one or more tradeable instruments for a given period of time. For example, when displaying the “Participant Comparison” dashboard, a user may right-click on the user interface which can generate a menu showing different options (e.g., “Drill on Trader & Date,” “Drill on Security). In one example, the user may right click on an entity circle in the graph, an entity segment in the trading metrics chart, and/or an entity's bar on the top entities graph. When selecting one of the menu option (e.g., “Drill on Participant Zoom”), the user interface may change display to show different views. In this example, the user can switch to a “Participant Zoom” dashboard from the “Participant Comparison” dashboard. This aspect is non-limiting though, and the user can access different views across the user interface regardless of which view/dashboard the user is currently viewing.

The “Participant Zoom” dashboard can focus on a single trader/account in which the display shows top securities in which the trader/account performed across multiple markets thereby allowing review of the contributions of each security to the trader/account total performance. In one non-limiting example, the graph in the “Participant Zoom” can include tradeable instrument 603 having points that are interconnected with lines along the graph. In one example, each point can depict how a participant performed with respect to a given tradeable instrument on a given date where each line is colored to correspond to a respective instrument. Each line can be connected between the points for the same instrument. Moreover, hovering over a particular point in the graph can result in a pop-up window being generated containing information for a security that the entity traded on a given day (e.g., market identifier, date, performance value, churn percentage, order to trade ratio, and/or total value).

It should be appreciated that various parameters may need to be set for loading the graphs and filters shown in the user interface for the “Participant Zoom.” These parameters and/or filters can be accessible in the portion of the interface containing the top performer area 641. In one non-limiting example, one parameter may include an entity type which can be defined as either an “account” or “trader” where another parameter may include an asset class that classifies the trading security type (e.g., an equity). An additional parameter may include a set entity box in which an input box may be provided for the user to type in the name of the entity (e.g., to search the entity directly). Another parameter may include a date range which relates to the time period covered in this view of the user interface, while another parameter may be a top parameter indicative a number of top performing securities (e.g., to be investigated). Yet another parameter could include a currency value indicative of the type of currency used in calculating the results displayed. The system can select any variety of currency including, at least, AUD, CAD, EUR, GBP, HKD, JPY, SGD, and USD. The currency value used in the conversion can be the midpoint price of the best bid and best ask at 4 PM (GMT) on a selected date. Another parameter could include a set mode parameter related to the type of mode displayable in the graph (e.g., daily, cumulative). If a daily mode is selected, the user interface may display a summary view of top performing securities selected based on their performance on the last trade date. If a cumulative mode is selected, the user interface may display a summary view of the top performing securities selected based on their cumulative performance over a defined date range. The user interface may also use various filters including, but not limited to, a market filter which lists markets traded by a chosen entity. Another filter may be a security filter that provides a list of securities traded by a chosen entity.

The user interface 600 can also include a trading metrics area 631. Similar to trading metrics area 630, the area 631 can include a bar graph showing a value of a tradeable instrument on a given day. In one example, each day could include a bar graph where the instrument's proportion of value for the day may be represented by how much their associated color is shown in the graph. For example, the percentage of color in the bar graph for a given instrument may reflect how that instrument performed relative to the other instrument colors. The bar graph in the trading metrics area 631 can show daily trading statistics for a chosen number of top performing securities over a given date rage (which can be aggregated across all markets for each security) where each bar can be divided into different color segments (each color corresponding to a separate security). Moreover, the user interface may also provide a drop-down button that allows the visualization to be changed to accommodate a user's preferred metrics. A list of such metrics with associated data elements, descriptions, and formulas is as follows:

Buy On Market Volume: total number of “on market” trades executed at ask price by the selected entity over the chosen trading period for each security across all markets by asset class.

Buy On Market Volume_Securityᵢ=ΣTrades at Ask Price_Securityᵢ (of an entity for security i)

Sell On Market Volume: total number of “on market” trades executed at bid price by the selected entity over the chosen trading period for each security across all markets by asset class.

Sell On Market Volume_Securityᵢ=ΣTrades at Bid Price_Securityᵢ (of an entity for security i)

Buy Value: daily total buy trading value of the selected entity for each one of the top securities across all markets by asset class converted to the chosen currency.

Buy Value_Securityᵢ=Entity Buy VWAP_Securityᵢ*Buy On Market Volume_Securityᵢ (of an entity for security i)

Sell Value: daily total sell trading value of the selected entity for each one of the top securities across all markets by asset class converted to the chosen currency.

Sell Value_Securityᵢ=Entity Sell VWAP_Securityᵢ*Sell On Market Volume_Securityᵢ (of an entity for security i)

Order Count: daily total number of enter orders submitted by the selected entity for each of the Top securities by asset class.

Order Count_Securityᵢ=ΣEnter Orders_Securityᵢ (of an entity for security i)

Delete Count: daily total number of delete orders submitted by the selected entity for each of the Top securities by asset class.

Delete Count_Securityᵢ=ΣDelete Orders_Securityᵢ (of an entity for security i)

Amend Count: daily total number of orders amended by the selected entity for each of the Top securities by asset class.

Amend Count_Securityᵢ=ΣAmend Orders_Securityᵢ (of an entity for security i)

Order Messages: daily total number of order messages, including enters, deletes and amends made by the selected entity for each of the Top T securities by asset class.

Order Messages_Securityᵢ=ΣEnter Orders_Securityᵢ+ΣDelete Orders_Securityᵢ+ΣAmend Orders_Securityᵢ (of an entity for security i)

Trade Count: daily total number of on-market trades made by the selected entity for each of the Top securities by asset class.

Trade Count_Securityᵢ=ΣBuy Trades_Securityᵢ+ΣSell Trades_Securityᵢ (of an entity for security i)

Buy Trade Count: daily total number of on-market buy trades executed by the selected entity for each of the Top securities by asset class.

Buy Trade Count_Securityᵢ=ΣBuy Trades_Securityᵢ (of an entity for security i)

Sell Trade Count: daily total number of on-market sell trades executed by the selected entity for each of the Top securities by asset class.

Sell Trade Count_Securityᵢ=ΣSell Trades_Securityᵢ (of an entity for security i)

Performance: selected entity's daily performance relative to the market performance for each security across all markets by asset class converted to the chosen currency. This metric can examine the performance of entities in terms of their security selection and timing of their order(s) against the benchmark (e.g., the market VWAP).

$${Performance\_Security}_{i} = ( Market VWAP - Entity Buy VWAP ) * Entity Buy On \text{-} Market {Volume\_Security}_{i} + ( Entity Sell VWAP - Market VWAP ) * Entity Sell On \text{-} Market {Volume\_Security}_{i} ( of an entity for security i )$$

Order to Trade Ratio: total number of order messages over the total number of trades per entity for each security across all markets by asset class on the chosen trading date.

Order-to-Trade Ratio_Securityᵢ=Order Messages_Securityᵢ/(Buy Trade Count₁₃Securityᵢ+Sell Trade Count₁₃Securityᵢ) (of an entity for security i)

Total Value: daily total traded value of the selected entity for each security across all markets by asset class.

Total Value_Securityᵢ=ΣTraded Value_Securityᵢ (of an entity for security i)

Churn %: approximate net position of each entity based on the frequency of buying and selling across their trading securities (can be calculated per entity for all securities across all markets by asset class for the chosen trading day). The Churn % can be calculated using any of the following methods:

If _{Buy On-Market Volume—}Security_{i>Sell On-Market Volume—}Securityᵢ, then _{Sell On-Market Volume—}Security_{i/Buy On-Market Volume—}Securityᵢ.

If _{Buy On-Market Volume—}Security_{i<Sell On-Market Volume—}Securityᵢ, then _{Buy On-Market Volume—}Security_{i/Sell On-Market Volume—}Securityᵢ.

If _{Buy On-Market Volume—}Security_{i=Sell On-Market Volume—}Securityᵢ, then the _{Churn %} will be 100%.

The user interface 600 may also show a top performer area 641. In one example, the top performer area 641 may show a bar graph similar to that shown in trading metric area 631, but each individual bar graph may only pertain to a performance of each tradeable instrument (for a participant) as of a last trade date. The bar graph can show direct comparison between performance of an entity's top performing security on a last day of a particular period, where each bar can represent a different security, identified by a security name (or other identifier). The top performer area 641 may also include options for setting the parameters and filters, discussed in detail above.

FIG. 6D shows another aspect of the non-limiting example user interface 600 illustrating further details related to a particular tradeable instrument. In one example, the display shown in FIG. 6D can correspond to a “drill down” feature of a “Security Zoom” dashboard (and can be drilled down using the methods discussed above). For example, FIG. 6D may show how one or more participants performed for a specific tradeable instrument (in this example, a security). It should be appreciated that the “Security Zoom” dashboard can focus on a single security in which a user can focus on the activities of the specific security in a defined market (with graphical representations for top trading participants on the security on a day to day basis). The dashboard may also include a market activity graph for the security on each day (which can be correlated with performance of specific entities on the security).

The user interface 600 shown in FIG. 6D includes a graph portion where performance of different participants of a given security can be displayed. In one example, a participant 604 may be represented as a line in a line graph where the line depicts the participant 604 performance for a given security over time. That is, each line for participant 604 could have multiple points where each point represents the participant's performance for a selected security and each participant may be assigned a specific color. The lines connecting each point can also be represented with the same color for the participant thereby conveying how that participant performed for a selected security over time. Circles on each line may represent the number of alerts generated by each entity for the selected security per day. It should be appreciated that the graph can provide the user a comparison of a chosen security's activity and the performance of top entities that have traded this particular security. A hover over event may also generate a pop-up window containing information on an entity that traded the security for the specific day (e.g., date, performance value, churn %, order to trade ratio, and/or total value).

It should also be appreciated that various parameters may need to be set for loading the graphs and filters shown in the user interface for the “Security Zoom.” These parameters and/or filters can be accessible in the portion of the interface containing the top performer area 642. In one non-limiting example, one parameter may include an entity type which can be defined as either an “account” or “trader” where another parameter may include a set market box which can be a text box for inserting the name of a market (e.g., for investigation). Another parameter may include a set security box which can be another text box for inserting the name of a security. Yet another parameter may include a date range which relates to the time period covered in this view of the user interface, while another parameter may be a top parameter indicative a number of top performing participants (e.g., to be investigated). Yet another parameter could include a currency value indicative of the type of currency used in calculating the results displayed. The system can select any variety of currency including, at least, AUD, CAD, EUR, GBP, HKD, JPY, SGD, and USD. The currency value used in the conversion can be the midpoint price of the best bid and best ask at 4 PM (GMT) on a selected date. Another parameter could include a set mode parameter related to the type of mode displayable in the graph (e.g., daily, cumulative). If a daily mode is selected, the user interface may display a summary view of top performing participants for a chosen security selected based on their performance on the last trade date. If a cumulative mode is selected, the user interface may display a summary view of the top performing participants for the chosen security selected based on their cumulative performance over a defined date range. The user interface may also use various filters including, but not limited to, an entity name filter which filters a list of entities that are top participants.

The display shown in FIG. 6D may also include a market activity area 632 that can include a candle chart showing a performance of a participant for the security (in a particular market) for a given day. As can be seen in FIG. 6D, certain portions of the candle chart in area 632 appear more dense than others which could be an indicator of high performance (or possible volatility). The candle chart can display the market activity for the security in terms of the total VWAP for the market per day (e.g., on a y-axis) and a total market volume (on the y-axis to the right) against the trade dates (on the x-axis). Moreover, hovering over a portion of a particular candle bar can generate a pop-up window containing information on the trading activity for the security on the specific day (e.g., date, opening and closing prices, high and low prices, currency, trade count, total volume, percentage of change from low to high, percentage of change from open to last, and/or VWAP). The user interface may also allow the visualization to be changed to accommodate a user's preferred metrics. A list of such metrics with associated data elements, descriptions, and formulas (where applicable) is as follows:

Open: opening price of the chosen security on the market for a particular trading day.

Low: lowest price of the chosen security on the market for a particular trading day.

High: highest price of the chosen security on the market for a particular trading day.

Last: closing price of the chosen security on the market for a particular trading day.

% Change Open to Last: price volatility measure calculated using the opening and closing prices of the chosen security for the selected trading day. This measure can be the percentage price change between the last price and the opening price.

% Open to Last M_Securityᵢ=(Last Price_Securityᵢ−Opening Price_Securityᵢ)/Opening Price_Securityᵢ (for security i)

% Change Low to High: price volatility measure calculated using the high and low prices of a security for the selected trading day in a particular market. This measure can be the percentage price change between the highest price and the lowest price.

% Low to High M_Securityᵢ=(High Price_Securityᵢ−Low Price_Securityᵢ)/Low Price_Securityᵢ (for security i)

Volume: aggregation of market volume (both buy and sell) over a chosen trading period for a particular security on the market.

On Market Volumeᵢ=Buy on Market Volume_Securityᵢ+Sell on Market Volume_Securityᵢ (of an entity for security i)

VWAP: volume weighted average price of all trades (both buy and sell) on the market for the security on the trading day in the local currency of the market.

$$Market VWAP = \frac{Market price * Mmarket volume at each transaction}{Total market volume}$$

Trade Count: daily total number of on-market trades for the selected security on the market.

Trade Count_Securityᵢ=ΣBuy Trades_Securityᵢ+ΣSell Trades_Securityᵢ (of an entity for security i)

Churn %: approximate net position of each entity based on the frequency of buying and selling on the selected security (see the formula above with respect to “Participant Zoom”).

Performance: daily performance of each one of the top entities relative to the market performance for the selected security across all markets converted to the chosen currency. This metric examines the performance of entities in terms of the security selected and timing of their order(s) against the benchmark, which can be the market VWAP (see formula above with respect to “Participant Zoom”).

Order to Trade Ratio: total number of order messages over the total number of trades of each entity for the chosen security and market per day (see formula above with respect to “Participant Zoom”).

Total Value: total traded value of each entity per day for the selected security converted to the chosen currency.

Total Value_Securityᵢ=ΣTraded Value_Securityᵢ (of an entity for security i)

Date: trading day for which the data is displayed.

Security Currency: original currency of the selected security before the application of the currency conversion.

The user interface 600 in FIG. 6D may also include a top performer area 642. In one example, the top performer area 642 may show a bar graph where each individual bar graph may pertain to a performance each participant (for a given tradable instrument) as of a last trade date. The top performer area 642 can show a direct comparison of performance of top entities that have traded the security calculated for the last day of a specific time period. Each bar in the bar graph may represent the participant identified by the participant name.

FIG. 6E shows another aspect of the non-limiting example user interface 600 related to performance details of an individual participant. In one example, the display shown in FIG. 6E can correspond to a “drill down” feature for a “Participant 360” dashboard indicative of a “360 degree view” of details related to a participant and their trading activity (e.g., for a selected day). The “Participant 360” dashboard can provide a comprehensive summary of a single participant's trading activities across all markets and all asset classes for a specified period of time. The trading statistics summarized in the dashboard can include the order to trade ratio, cancellation rate, breakdown of trading behavior per market, average lifetime of an order, and/or trade/fill analysis (among others). The dashboard may also contain a “scatterplot” which is a visual representation of the relationship between the churn %, performance, % fully cancel, and/or the traded value.

The user interface 600 shown in FIG. 6E can include a performance summary 650 for a selected participant. The performance summary 650 can include information summarizing trade performance that includes, but is not limited to, a total number of order messages submitted by the participant, a total number of trades, a total value of trades, a total alert number, a performance amount, an average churn value (e.g., average churn percentage), an average order to trade ratio, and/or an average fully cancelled order percentage. The performance summary may also include a portion showing traded value by asset class and traded value by market (shown as bar graphs in this non-limiting example). The traded value by asset class bar graph plots total traded value (y-axis) converted to a chosen currency against asset classes (x-axis) traded by a chosen participant. The traded value by market graph plots total traded value (y-axis) converted to a chosen currency against markets (x-axis) in which the chosen participant traded.

The user interface 600 may also include a performance chart 651. In one non-limiting example, the performance chart 651 may show a turnover by performance measure for one or more tradeable instruments. For example, the performance chart 651 may show a performance with respect to churn ratio represented by circular objects. In further detail, the performance chart 651 may provide a “scatterplot” that displays the relationship between the churn % (x-axis) and the performance (y-axis) for all securities traded by an entity (values converted to a chosen currency). In one example a color of a circular object may be indicative of a percentage of fully canceled order(s) while a size of a circle can represent a total traded value or the order to trade ratio. In one example, a blue circle may correspond to 0% fully canceled while a red circle may correspond to 100% fully canceled. The y-axis may also be customized to represent either performance or relative performance per unit bps of the participant. If a user clicks on a “size” drop-down, the size of the circles can be customized to represent the total traded value or the order to trade ratio while clicking on a “Y” drop-down can enable the user to see the relationship between the churn % and the relative performance of the entity. Additionally, hovering the mouse over a particular circle will generate a pop-up window containing information for the particular security that the participant traded on the specific day. The user interface may also allow the visualization to be changed to accommodate a user's preferred metrics. A list of such metrics with associated data elements, descriptions, and formulas (where applicable) is as follows:

Total Traded Value: daily total traded value of the chosen entity for all securities across all selected markets and asset classes on a specific date.

Total Traded Value=Σᵢ₌₁^{all} Total Traded Value_Securityᵢ (of an entity)

Total Traded Value CCY: metric for the Total Trade Value converted to the selected currency.

Total Trade #: total number of trades executed by the chosen entity for all securities across all selected markets and asset classes on a specific date.

Total Trade #=Σᵢ₌₁^{all} BuyTrades_Securityᵢ+Σᵢ₌₁^{all} SellTrades_Securityᵢ (of an entity)

Total Order Messages #: total number of order messages, including enters, deletes and amends made by the selected entity for all securities across all markets by asset class on a specific date.

Total Order Messages=Σᵢ₌₁^{all} OrderCount₁₃Securityᵢ+Σᵢ₌₁^{all} DeletedCount_Securityᵢ+Σᵢ₌₁^{all} AmendCount_Securityᵢ (of an entity across all markets)

Performance: an entity's daily performance relative to the market performance across all securities for the selected markets and asset classes. This metric can examine the performance of entities in terms of their security selection and timing of their order(s) against the benchmark (which can be the market VWAP).

$${Performance\_Security}_{i} = ( Market VWAP - Entity Buy VWAP ) * Entity Buy On \text{-} Market {Volume\_Security}_{i} + ( Entity Sell VWAP - Market VWAP ) * Entity Sell On \text{-} Market {Volume\_Security}_{i} Performance\_All Securities for an entity = {\sum }_{i = 1}^{all} {Performance\_Security}_{i} by market and asset class$$

Performance CCY: metric for the Performance converted to the selected currency.

Asset Class: classification of the trading security type.

Market: a market code.

The user interface 600 may also include a trading activity area 652 showing individual trading details for a given participant. In one non-limiting example, the trading activity area 652 can include line item details for each tradeable instrument that has been submitted/traded by the participant shown in this view. For example, each line item detail can include a tradeable instrument (e.g., security), a performance value, a type of market, a “long name” of the instrument, churn percentage, buy and/or sell value. This example is of course non-limiting and each line item detail can include any variety of information both shown and not shown in FIG. 6E. The trading activity area 652 may show daily trading activity for all securities traded by a participant where “pressing” on a square in “summary,” “security info” and “trade details” (not shown) tabs will allow the user to expand/collapse these respective tabs. Moreover, “pressing” on the top of each column can enable sorting of the values in the respective columns (e.g., alphabetically, numerically, ascending, descending). The user interface may also allow the visualization to be changed to accommodate a user's preferred metrics. It should be appreciated that if a date range is longer than one day, the figures displayed for all volume and value metrics, number of trading activities, performance and relative performance will be calculated by summing daily metrics values across the date range. The figure for percentage metrics, such as Churn %, will be calculated by taking the average of the daily metrics values across the date range. A list of these metrics with associated data elements, descriptions, and formulas (where applicable) is as follows:

Security: a security code.

Performance: selected entity's daily performance relative to the market performance for each security across all markets by asset class converted to the chosen currency. This metric examines the performance of entities in terms of their security selection and timing of their order(s) against the benchmark, which can be the market VWAP (see formula above with respect to “Participant Zoom”).

Performance CCY: metric for the Performance converted to the selected currency.

Relative Performance per Unit Bps: measure of how one entity outperforms the market per traded unit of the trading security (in basis points).

$$Relative {Performance\_Security}_{i} = [ \frac{\begin{matrix}ln ( \frac{VWAP\_Sell \_Entity}{Benchmark} ) \times {Sell\_volume}_{Entity} + \\ ln ( \frac{Benchmark}{VWAP\_Buy \_Entity} ) \times {Buy\_volume}_{Entity}\end{matrix}}{( {Sell}_{{volume}_{Entity}} + {Buy}_{{volume}_{Entity}} )} ] * 10000$$

The benchmark is “VWAP on-market others”, which is the on-market VWAP excluding own entity transactions.

$$ln ( \frac{VWAP\_Sell \_Entity}{Benchmark} )$$

measures the selling performance compared to the benchmark.
   Positive value indicates profit or negative value indicates loss.

$$( \frac{Benchmark}{{VWAP}_{—} {Buy}_{—} Entity} )$$

measures the buying performance compared to the benchmark.
   Positive value indicates profit or negative value indicates loss.

Market: market for which the data is displayed.

Security Longname: full name of the security.

Date: trading day for which the data is displayed.

% Low to High: price volatility measure calculated using the high and low prices of a security for the selected trading day in a particular market. This measure is the percentage price change between the highest price and the lowest price.

% Low to High M_Securityᵢ=(High Price_Securityᵢ−Low Price_Securityᵢ)/Low Price_Securityᵢ (for security i)

Low Price: lowest price for a security in a particular market for a specific trading day.

High Price: highest price for a security in a particular market for a specific trading day.

% Open to Last: price volatility measure calculated using the opening and last prices of a security for the selected trading day in a particular market. This measure is the percentage price change between the last price and the opening price.

% Open to Last M_Securityᵢ=(Last Price_Securityᵢ−Opening Price_Securityᵢ)/Opening Price_Securityᵢ (for security i)

Opening Price: opening price for a security in a particular market for a specific trading day.

Last Price: closing price for a security in a particular market for a specific trading day.

On Market Volume: aggregation of market volume (both buy and sell) over a chosen trading period for a particular security.

On Market Volumeᵢ=Buy on Market Volume_Securityᵢ+Sell on Market Volume_Securityᵢ (of an entity for security i)

Buy On Market Trades: number of on-market buy trades executed by the chosen entity for each security on a specific date.

Buy Trade Count_Securityᵢ=ΣBuy Trades_Securityᵢ (of an entity for security i)

Buy On Market Volume: total buy volume traded by the chosen entity over the chosen trading period for a particular security (see formula above with respect to “Participant Zoom”).

Sell On Market Trades: number of on-market sell trades executed by the chosen entity for each security on a specific date.

Sell Trade Count₁₃Securityᵢ=ΣSell Trades_Securityᵢ (of an entity for security i)

Sell On Market Volume: total sell volume traded by the chosen entity over the chosen trading period for a particular security (see formula above with respect to “Participant Zoom”).

Churn %: approximate net position of the chosen entity based on the frequency of buying and selling of their trading securities (see formula above with respect to “Participant Zoom”).

Buy Value: daily total buy trading value for the chosen entity for a particular security converted to the chosen currency (see formula above with respect to “Participant Zoom”).

Buy Value CCY: metric for the Buy Value converted to the selected currency.

Sell Value: daily total sell trading value for the chosen entity for a particular security converted to the chosen currency (see formula above with respect to “Participant Zoom”).

Sell Value CCY: metric for the Sell Value converted to the selected currency.

Total Value: daily total traded value of the chosen entity per security for the selected markets (see formula above with respect to “Participant Zoom”).

Total Value CCY: metric for the Total Value converted to the selected currency.

Order to Trade Ratio: total number of order messages over the total number of trades for the chosen entity for each security for the selected markets on the chosen trading date (see formula above with respect to “Participant Zoom”).

Trade Count: daily total number of on-market trades executed by the chosen entity per security across all markets by asset class on a specific date (see formula above with respect to “Participant Zoom”).

Order Messages: daily total number of order messages, including enters, deletes and amends made by the selected entity for each security across all markets by asset class (see formula above with respect to “Participant Zoom”).

Order Count: daily total number of enter orders submitted by the selected entity for each security across all markets by asset class (see formula above with respect to “Participant Zoom”).

Delete Count: daily total number of delete orders submitted by the selected entity for each security across all markets by asset class (see formula above with respect to “Participant Zoom”).

Amend Count: daily total number of orders amended by the selected entity for each security across all markets by asset class (see formula above with respect to “Participant Zoom”).

% Fully Cancelled Order: total number of orders which were fully cancelled by the chosen entity as a percentage of their total number of orders.

% Fully Cancelled Order_Securityᵢ=(Fully Cancelled Order Count_Securityᵢ)/(Order Messages_Securityᵢ) (of an entity for security i)

% Order at Priority: total number of orders at priority submitted by the selected entity for each security as a percentage of his/her total number of enter orders submitted.

% Order at Priority_Securityᵢ=(Order at Priority Count_Securityᵢ)/(Order Count_Securityᵢ) (of an entity for security i)

% Order at Best Bid and Ask: total number of orders submitted at the best price (whether bid or ask) as a percentage of the total number of orders submitted.

% Order at Best Bid and Ask_Security (Order at Best Bid and Ask Count_Securityᵢ)/(Order Count_Securityᵢ) (of an entity for security i)

Average Resting Time: an average estimate of order lifetime in the order book.

Lifetime of order (expressing in milliseconds)=The timestamp, at which the order got executed/deleted/cancelled/amended in the book−The timestamp, at which the order got entered in the book

The user interface 600 may also include filter options 653 that are used to filter the information shown based on one or more criteria. It should be appreciated that various parameters may need to be set for loading the graphs and filters shown in the user interface for the “Participant 360.” In one non-limiting example, one parameter may include an entity type which can be defined as either an “account” or “trader” where another parameter may include a set entity box for inputting the name of an entity. In one example, a user may search by directly inputting the entity name into the set entity box after selecting the entity type. Another parameter may include a date range which relates to the time period covered in this view of the user interface. Yet another parameter could include a currency value indicate of the type of currency used in calculating the results displayed. The system can select any variety of currency including, at least, AUD, CAD, EUR, GBP, HKD, JPY, SGD, and USD. The currency value used in the conversion can be the midpoint price of the best bid and best ask at 4 PM (GMT) on a selected date.

The user interface may also use various filters including, but not limited to, a market filter which lists markets traded by the participant. Another filter may include an asset class filter which lists asset classes traded by the participant. Yet another filter could include a security name box in which the user can filter by name of a security of interest (e.g., via an input text box). The user interface is configured to use a variety of additional filters including, but not limited to, performance CCY, churn %, % fully cancelled order, % open to last, % low to high, buy on market volume, sell on market volume, order messages, trade count, and/or order to trade ratio.

FIG. 6F shows yet another aspect of the non-limiting example user interface 600. In one example, the display shown in FIG. 6F can correspond to an “Order Analysis” dashboard showing order information for different participants. The “Order Analysis” dashboard is designed to enable users to gain a better insight into the approximate order flow characteristics of each entity (account or trader) across all markets and asset classes. The dashboard presents information about price/fill status at multiple price levels of the order book, and also provides details of the lifetime of the order (which could be either executed via market order or limit order). The dashboard can display a first table showing per participant the orders information (e.g., price, proximity from best bid/ask), fill status (% fully canceled/filled), ratio of canceled orders, and/or partially filled (among others). A scatterplot can display the correlation between various order characteristics chosen by a user and a second table can highlight per participant the order life-time (e.g., average resting time). The dashboard can also provide another view showing a dynamic graph showing trends in participants order activities.

For example, the display can include a price and fill status area 654 indicative of price and fill status based order statistics per participant for a selected period of time. For example, the price and fill status area 654 can include individual line item entries for each entity providing detailed information related to order counts, alert counts, average fully or partially filled, canceled, or incomplete. This list of items is of course non-limiting and each line item detail in area 654 can include any variety of information both shown and not shown in FIG. 6F. The table may also be color coded in one or more columns (e.g., average % fully canceled, average % at priority, and average % order best bid ask). In one non-limiting example, as the value of the metrics approaches 100%, the color moves to red, whereas the value of the metrics approaches 0%, the color moves to blue. In a further example, when the value for the metrics approaches 50%, the color may become closer to white. Providing input to the top of each column may also enable the column to be sorted accordingly.

The display can further include a time based order area 655 indicative of a time based order statistics per participant for a selected period of time. In one non-limiting example, the time based order area 655 can include individual line item entries for each entity (similar to area 654) providing detailed information related to order messages, trade counts, and/or different values related to average life time percentage of an order for different intervals of time. This list of items is of course non-limiting and each line item detail in area 655 can include any variety of information both shown and not shown in FIG. 6F. The table shown in this portion highlights the order life-time (e.g., average resting time) per entity. The table can be colored coded in various columns (e.g., average % amends, average % life-time=0 ms, average % life-time<=1 ms, and/or average % life-time=1 s). In one non-limiting example, as the value of the metrics approaches 100%, the color moves to red, whereas the value of the metrics approaches 0%, the color moves to blue. In a further example, when the value for the metrics approaches 50%, the color may become closer to white. Providing input to the top of each column may also enable the column to be sorted accordingly.

The interface 600 may also include a correlation area 656 indicative of a correlation of order statistics on a participant level. Such information could be represented as a graph including different bubble objects where the size of each bubble object could represent a correlation value. In more detail, the correlation area 656 could include a scatterplot that displays the correlation between various order characteristics chosen by year. In one example, the metrics for the x- and y-axes are configurable and include metrics such as alert count, order count, average % order best bid ask, among others. The size of the circles may also be customized to represent the order count, trade count, and/or order messages. Moreover, if a user clicks on a “Size” dropdown, the user can customize the size of the circles to represent order count, trade count, and/or order messages. Additionally, hovering the mouse over a particular circle will generate a pop-up window that contains information for an entity's order (e.g., order count, average % order best bid ask, and/or average % life time=0 ms). The user interface may also allow the visualization to be changed to accommodate a user's preferred metrics. A list of such metrics with associated data elements, descriptions, and formulas (where applicable) is as follows:

Entity Name: a particular trader or account.

Order Count: total number of enter orders submitted at various price steps across all of the entity's traded securities.

Order Count=Σᵢ₌₁^{all} Enter Orders_Securityᵢ (of an entity)

Alert Count: total number of primary alerts triggered at trader or account level on the system over the chosen trading dates for all securities across all markets plus the EComm alerts.

Alert Count=Σᵢ₌₁^{all} TradeAlerts_Marketᵢ+ΣEcommAlerts (of an entity on a specific day)

Avg % Fully Filled: average percentage of orders, which were fully executed over the course of the trading period. The formula is as of follows:

Step 1:

$$\% Number of Fully filled Orders for each security = \frac{\begin{matrix}\begin{matrix}The total \\ number of\end{matrix} \\ orders which \\ got fully \\ traded out\end{matrix}}{\begin{matrix}Total number \\ of orders \\ messages\end{matrix}} \times 100 \%$$

Step 2:

Avg % Fully Filled=Average number of Fully Filled order (1) across all securities traded by one entity (Grouped by market and asset class)

Avg % Partially Filled: average percentage of orders, which were only partially executed. The remaining bid/ask volume would be automatically re-entered into the book as a new order.

Step 1:

$$\% Partially Filled order for each security = \frac{\begin{matrix}The total \\ number of \\ orders , which \\ got partially \\ filled\end{matrix}}{\begin{matrix}total number \\ of order \\ messages\end{matrix}} \times 100 \%$$

Step 2:

Avg % Fully Filled=Average figure of partially filled order (1) across all securities traded by a one entity (Grouped by market and asset class)

Avg % Fully Cancelled: average number of orders which were fully cancelled per entity across all markets and securities as a percentage of their total number of entered orders.

Step 1:

% Fully Cancelled Order_Securityᵢ=(Fully Cancelled Order Count_Securityᵢ)/(Order Messages_Securityᵢ) (of an entity for security i)

Step 2:

Avg % Fully Cancelled=Average Figure of Cancelled Order (1) across all securities for each entity (Grouped by market and asset class)

Avg % Incomplete: average percentage of orders, which remain in the book without being executed.

Step 1:

$$\% Incomplete order for each security = \frac{\begin{matrix}The total number \\ of orders , which \\ never trade\end{matrix}}{\begin{matrix}total number of \\ order messages\end{matrix}} \times 100 \%$$

Step 2:

Avg % Incomplete=Average Figure of the number of Incomplete Orders (1) across all securities for each entity. (Grouped by market and asset class)

Avg % at Priority: average percentage of orders entered into the book across all securities.

Step 1:

$$\% Number of At priority orders for each security = \frac{\begin{matrix}The total \\ number \\ of priority \\ orders\end{matrix}}{\begin{matrix}total \\ number \\ of order \\ messages\end{matrix}} \times 100 \%$$

Step 2:

Avg at Priority=Average Figure of the number of At Priority Orders (1) across all securities for each entity. (Grouped by market and asset class)

Avg % Order at Best Bid Ask: average percentage of limit orders, which were entered at the best price.

Step 1:

$$\% Number of Orders entered at best price for each security = \frac{\begin{matrix}The total number of \\ market orders\end{matrix}}{\begin{matrix}total number of \\ order messages\end{matrix}} \times 100 \%$$

Step 2:

Avg % Order a Best Bid Ask=Average of all orders entered at best price (1) across all securities for each entity (Grouped by market and asset class)

Avg % 1 Tick away: average percentage of limit orders, which were entered at 1 tick away from the best price.

Step 1:

$$\% Number of Orders entered at 1 tick away for each security = \frac{\begin{matrix}The total number of \\ 1 tick away orders\end{matrix}}{\begin{matrix}total number of \\ order messages\end{matrix}}$$

Step 2:

Avg % 1 Tick Away=Average of all orders entered at 1 tick away (1) across all securities for each entity. (Grouped by market and asset class)

Avg %>1 Tick away: average percentage of limit orders which were entered at more than 1 tick away from the best price.

Step 1:

$$\% Number of Orders entered more than 1 tick away for each security = \frac{\begin{matrix}The total number \\ of more than 1 \\ tick away orders\end{matrix}}{\begin{matrix}total number of \\ order messages\end{matrix}} \times 100 \%$$

Step 2:

Avg % 1 Tick away=Average of all orders entered at more than 1 tick away (1) across all securities for each entity. (Grouped by market and asset class)

Order Messages: total number of order messages, including enters, deletes and amends submitted by an entity across all their securities traded over a chosen time period. The formula is presented as follows:

Order Messages=Σᵢ₌₁^{all} OrderCount_Securityᵢ+Σᵢ₌₁^{all} DeletedCount₁₃Securityᵢ+Σᵢ₌₁^{all} AmendCount₁₃Securityᵢ (of an entity across all markets)

Avg % Amends: average percentage of enter messages that are amends.

Step 1:

$$\% Amends = \frac{total number of Amends}{total number of Order messages} \times 100 \%$$

Step 2:

Avg % Amends=Average of the percentage of amends (1) for all securities for an entity on the selected markets for the date range selected. (Grouped by market and asset class)

Average Resting Time: average time each order is in the order book without executing for each entity across all securities on the selected markets for the date range selected.

Lifetime of order (expressing in milliseconds)=The timestamp, at which the order got executed/deleted/cancelled/amended in the book−The timestamp, at which the order got entered in the book

Avg % Life Time=0 ms: average percentage of orders that are in the order book for 0 milliseconds.

Step 1:

$$\% Orders with Life Time = 0 ms = \frac{\begin{matrix}Orders in the orderbook \\ for a total lifetime of 0 ms\end{matrix}}{\begin{matrix}Total number of orders \\ in the orderbook\end{matrix}} \times 100 \%$$

Step 2:

Avg % Life Time=0 ms=average of all the percentages of orders with Life Time=0 ms (1) for all securities for an entity on the selected markets for the date range selected. (Grouped by market and asset class)

Avg % Life Time<=1 ms: average percentage of orders that are in the order book for less than or equal to 1 millisecond.

Step 1:

$$\% Orders with Life Time \text{<=} 1 ms = \frac{\begin{matrix}Orders in the orderbook for \\ a total lifetime of \leq 1 ms\end{matrix}}{\begin{matrix}Total number of orders \\ in the orderbook\end{matrix}} \times 100 \%$$

Step 2:

Avg % Life Time<=1 ms=Average of all the percentages of orders with Life Time<=1 ms (1) for all securities for an entity on the selected markets for the date range selected. (Grouped by market and asset class)

Avg % Life Time<=10 ms: average percentage of orders that are in the order book for less than or equal to 10 milliseconds.

Step 1:

$$\% Orders with Life Time \text{<=} 10 ms = \frac{\begin{matrix}Orders in the orderbook for \\ a total lifetime of \leq 10 ms\end{matrix}}{\begin{matrix}Total number of orders \\ in the orderbook\end{matrix}} \times 100 \%$$

Step 2:

Avg % Life Time<=10 ms=Average of all the percentages of orders with Life Time<=10 ms (1) for all securities for an entity on the selected markets for the date range selected. (Grouped by market and asset class)

Avg % Life Time=1 s: average percentage of orders that are in the order book for 1 second.

Step 1: is

$$\% Orders with Life Time = 1 s = \frac{\begin{matrix}Orders in the orderbook for \\ a total lifetime of = 1 s\end{matrix}}{\begin{matrix}Total number of orders \\ in the orderbook\end{matrix}} \times 100 \%$$

Step 2:

Avg % Life Time=1 s=Average of all the percentages of orders with Life Time=1 s (1) for all securities for an entity on the selected markets for the date range selected. (Grouped by market and asset class)

Avg % Life Time>1 s: average percentage of orders that are in the order book for over 1 second.

Step 1:

$$\% Orders with Life Time > 1 s = \frac{\begin{matrix}Orders in the orderbook for \\ a total lifetime of > 1 s\end{matrix}}{\begin{matrix}Total number of orders \\ in the orderbook\end{matrix}} \times 100 \%$$

Step 2:

Avg % Life Time>1 s=Average of all the percentages of orders with Life Time>1 s (1) for all securities for an entity on the selected markets for the date range selected. (Grouped by market and asset class)

Trade Count: daily total number of on-market trades executed per entity for all securities across all markets by asset class.

Trade Count=Σᵢ₌₁^{all} BuyTrades_Securityᵢ+Σᵢ₌₁^{all} SellTrades_Securityᵢ (of an entity)

Order to Trade: total number of order messages over the total number of trades of each entity for a particular security and market per day.

Order-to-Trade Ratio_Securityᵢ=Order Messages_Securityᵢ/(Buy Trade Count_Securityᵢ+Sell Trade Count₁₃Securityᵢ) (of an entity for security i)

The display may also include an order analysis filter area 657 that can filter information shown based on one or more criteria. It should be appreciated that various parameters may need to be set for loading the graphs and filters shown in the user interface for the “Order Analysis.” In one non-limiting example, one parameter may include an entity type which can be defined as either an “account” or “trader” where another parameter may include an asset class that classifies the trading security type (e.g., an equity). Another parameter may include a date range which relates to the time period covered in this view of the user interface. The user interface may also use various filters including, but not limited to, a market filter which lists markets traded a participant. Another filter may be an entity name filter which can be a text box for inserting a name of the entity. Yet another filter could be an asset class filter which lists asset classes traded by the entities. Additional filters are also available including, but not limited to, alert count, order messages, order count, trade count, order to trade, average % fully cancelled, average % fully filled, and/or average % life time=0 ms.

FIG. 6G shows another non-limiting example user interface 600 showing performance outliers. In one non-limiting example, the display shown in FIG. 6G can correspond to an “Outlier Analysis” dashboard providing information related to participant performance outliers. The view can demonstrate a specific number (e.g., outlier limit) of participants' performance per security on each day of the period where the analysis can be performed across all asset classes and markets. The display can include a scatterplot showing the relationship between churn % (x-axis), performance value (y-axis) and trade value (e.g., size of a respective circle). Color may be used to link % fully cancelled order or order to trade ratio. In one example, a relatively high “performance” with very low churn % may indicate trading based on unpublicized information (i.e., “insider trading”). Alternatively, high performance with high churn % and high order to trade ratio may indicate possible order book manipulation (e.g., “spoofing”). An additional visualization may group performance per security or per participant and can provide a broader picture of the most profitable/losing securities or participant.

The display may also include an outlier analysis filter area 658 that can filter information (or establish parameters) shown based on one or more criteria. It should be appreciated that various parameters may need to be set for loading the graphs and filters shown in the user interface for the “Outlier Analysis.” In one non-limiting example, one parameter may include an entity type which can be defined as either an “account” or “trader.” Another parameter may include a date range which relates to the time period covered in this view of the user interface. Another parameter may include an outlier number limit which corresponds to the number of outliers “investigated” in this view. In one example, setting an outlier limit of 100, will make the dashboard display information on the top 100 entities which are most different from the average characteristics of the total number of entities. Outliers, being the most extreme observations, may include both sample maximum and minimum characteristics. For example, the dashboard will display information on entities with the highest Churn %, as well as with lowest Churn %. Yet another parameter could include a currency value indicative of the type of currency used in calculating the results displayed. The system can select any variety of currency including, at least, AUD, CAD, EUR, GBP, HKD, JPY, SGD, and USD. The currency value used in the conversion can be the midpoint price of the best bid and best ask at 4 PM (GMT) on a selected date. The user interface may also use various filters including, but not limited to, a market filter which lists markets that are traded by the entities included in the outlier limit. Another filter may be an entity name filter which filters a list of entities included in the outlier limit Yet another filter may include an asset class filter that provides a list of asset classes traded by the entities included in the outlier limit. Another filter may include a security filter which provides a list of securities that are traded by the entities included in the outlier limit Additional filters may be available in which a user may further refine the search. These additional filters include, but are not limited to, performance CCY, churn %, % fully cancelled order, order to trade ratio, order messages, and/or total traded value CCY. The dashboard may also include search filters which could provide a text box for the user to insert the name of the party/filter to be searched.

The user interface 600 may also include an outlier graph 659 showing a scatterplot that shows the relationship between the churn % (x-axis) and the metrics chosen (y-axis) which could include, at least, performance CCY or relative performance per unit BPS. In one example, the size of the circles can depend on the traded value where the color of the circles can be customized to represent either % fully cancelled order or the order to trade ratio. In one example, as the value of these metrics approaches 100%, the color moves to red, whereas the value of these metrics approaches 0%, the color moves to blue. In a further example, when the value for the metrics approaches 50%, the color becomes closer to white. By clicking on a “Color” drop-down, the user can customize the color of the circles to represent either fully cancelled orders or the order to trade ratio. Moreover, hovering the mouse over a particular circle can generate a pop-up window providing information on an order placed by an entity on a particular day for a specific security (e.g., traded value CCY, churn %, performance CCY, market, % fully cancelled order, order to trade ratio, order count, order messages, and/or trade count).

The user interface 600 may also include a security performance area 660 showing performance values for each security and/or entity. In the example shown in FIG. 6G, the area 660 may include at least three charts. One chart may be a “By Security” graph showing the performance value for each security (which can be customized to show only top, bottom, or both top and bottom securities). Another chart may be a “By Entity” graph showing performance value of each entity (which can be customized to show only top, bottom, or both top and bottom entities). Yet another chart may be a “By Entity” scatterplot (similar to the “By Entity” chart) which allows the user to spot any outlier performance by correlating the churn % (x-axis) and performance value (y-axis). The area 660 may provide an overall picture of the top most profitable securities and entities (with aggregated figures) sorted by performance value. Several filters, such as, performance, churn, fully cancelled order ratio, order messages, and/or total value are available as well.

Moreover, the user interface may also allow the visualization to be changed to accommodate a user's preferred metrics. A list of such metrics with associated data elements, descriptions, and formulas (where applicable) is as follows:

% Fully Cancelled Order: total number of orders which were fully cancelled per entity per security as a percentage of his/her total number of order messages per security (see formula above with respect to “Participant 360” dashboard).

Order to Trade Ratio: total number of order messages over the total number of trades of each entity for a particular security and market per day (see formula above with respect to “Participant Zoom” dashboard).

Top: top performing entities or securities.

Bottom: bottom performing entities or securities.

Performance CCY in the ‘By Entity’ bar chart and scatterplot: an entity's daily performance relative to the market performance across all securities and all markets by asset class converted to the chosen currency. This metric can examine the performance of entities in terms of their security selection and timing of their order(s) against the benchmark (which can be the market VWAP).

$${Performance}_{—} {Security}_{i} = ( Market VWAP - Entity Buy VWAP ) * Entity Buy On \text{-} Market {Volume}_{—} {Security}_{i} + ( Entity Sell VWAP - Market VWAP ) * Entity Sell On \text{-} Market {Volume}_{—} {Security}_{i}$$

$${Performance}_{—} All Securities for an entity = {Σ}_{i = 1}^{au} {Performance}_{—} {Security}_{i} by market and asset class$$

Performance CCY in the Main Scatterplot and ‘By Security’ bar chart: an entity's daily performance relative to the market performance per security across all markets by asset class converted to the chosen currency. This metric can examine the performance of entities in terms of their security selection and timing of their order(s) against the benchmark (which can be the market VWAP).

Churn %: the approximate net position of each entity based on the frequency of buying and selling of their trading securities (see formula above with respect to “Participant Zoom”).

Relative Performance per Unit bps: a measure of how one entity outperforms the market per traded unit of the trading security (in basis points) (see formula above with respect to “Participant 360” dashboard).

It should be appreciated that the examples and user interfaces described herein are non-limiting and the technology envisions a variety of methods for generating user interfaces and allowing the user to “drill down” into one or more different views. In one example embodiment, the user interfaces may be accessed from a “spread view” which is shown in co-pending U.S. provisional patent application No. 62/514,409 (incorporated herein by reference). Moreover, the terms above refer to “participants” but this example is non-limiting and it should be appreciated that “participants” could also refer to “entity,” “trader,” “account,” or the like. Moreover, the examples described herein are with respect to securities but it should be appreciated that this example is non-limiting and the technology envisions the techniques applied herein as relevant to any other type of tradeable instrument.

### Description of FIG. 7

FIG. 7 shows a non-limiting example block diagram of a hardware architecture for the system 1260. In the example shown in FIG. 7, the client device 1210 communicates with a server system 1200 via a network 1240. The network 1240 could comprise a network of interconnected computing devices, such as the internet. The network 1240 could also comprise a local area network (LAN) or could comprise a peer-to-peer connection between the client device 1210 and the server system 1200. As will be described below, the hardware elements shown in FIG. 7 could be used to implement the various software components and actions shown and described above (relative to FIGS. 2 and 3, and in other places) as being included in and/or executed at the client device 1210 and server system 1200.

In some embodiments, the client device 1210 (which may also be referred to as “client system” herein) includes one or more of the following: one or more processors 1212; one or more memory devices 1214; one or more network interface devices 1216; one or more display interfaces 1218; and one or more user input adapters 1220. Additionally, in some embodiments, the client device 1210 is connected to or includes a display device 1222. As will explained below, these elements (e.g., the processors 1212, memory devices 1214, network interface devices 1216, display interfaces 1218, user input adapters 1220, display device 1222) are hardware devices (for example, electronic circuits or combinations of circuits) that are configured to perform various different functions for the computing device 1210.

In some embodiments, each or any of the processors 1212 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1212 uses an instruction set architecture such as x86 or Advanced RISC Machine (ARM).

In some embodiments, each or any of the memory devices 1214 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1212). Memory devices 1214 are examples of non-volatile computer-readable storage media.

In some embodiments, each or any of the network interface devices 1216 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 1218 is or includes one or more circuits that receive data from the processors 1212, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 1222, which displays the image data. Alternatively or additionally, in some embodiments, each or any of the display interfaces 1218 is or includes, for example, a video card, video adapter, or graphics processing unit (GPU).

In some embodiments, each or any of the user input adapters 1220 is or includes one or more circuits that receive and process user input data from one or more user input devices (not shown in FIG. 7) that are included in, attached to, or otherwise in communication with the client device 1210, and that output data based on the received input data to the processors 1212. Alternatively or additionally, in some embodiments each or any of the user input adapters 1220 is or includes, for example, a PS/2 interface, a USB interface, a touchscreen controller, or the like; and/or the user input adapters 1220 facilitates input from user input devices (not shown in FIG. 7) such as, for example, a keyboard, mouse, trackpad, touchscreen, etc. . . . .

In some embodiments, the display device 1222 may be a Liquid Crystal Display (LCD) display, Light Emitting Diode (LED) display, or other type of display device. In embodiments where the display device 1222 is a component of the client device 1210 (e.g., the computing device and the display device are included in a unified housing), the display device 1222 may be a touchscreen display or non-touchscreen display. In embodiments where the display device 1222 is connected to the client device 1210 (e.g., is external to the client device 1210 and communicates with the client device 1210 via a wire and/or via wireless communication technology), the display device 1222 is, for example, an external monitor, projector, television, display screen, etc. . . . .

In various embodiments, the client device 1210 includes one, or two, or three, four, or more of each or any of the above-mentioned elements (e.g., the processors 1212, memory devices 1214, network interface devices 1216, display interfaces 1218, and user input adapters 1220). Alternatively or additionally, in some embodiments, the client device 1210 includes one or more of: a processing system that includes the processors 1212; a memory or storage system that includes the memory devices 1214; and a network interface system that includes the network interface devices 1216.

The client device 1210 may be arranged, in various embodiments, in many different ways. As just one example, the client device 1210 may be arranged such that the processors 1212 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the client device 1210 may be arranged such that: the processors 1212 include two, three, four, five, or more multi-core processors; the network interface devices 1216 include a first network interface device that implements Ethernet and a second network interface device that implements WiFi and/or Bluetooth; and the memory devices 1214 include a RAM and a flash memory or hard disk.

Server system 1200 also comprises various hardware components used to implement the software elements for server system 200 of FIG. 2. In some embodiments, the server system 1200 (which may also be referred to as “server device” herein) includes one or more of the following: one or more processors 1202; one or more memory devices 1204; and one or more network interface devices 1206. As will explained below, these elements (e.g., the processors 1202, memory devices 1204, network interface devices 1206) are hardware devices (for example, electronic circuits or combinations of circuits) that are configured to perform various different functions for the server system 1200.

In some embodiments, each or any of the processors 1202 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1202 uses an instruction set architecture such as x86 or Advanced RISC Machine (ARM).

In some embodiments, each or any of the memory devices 1204 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1202). Memory devices 1204 are examples of non-volatile computer-readable storage media.

In some embodiments, each or any of the network interface devices 1206 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In various embodiments, the server system 1200 includes one, or two, or three, four, or more of each or any of the above-mentioned elements (e.g., the processors 1202, memory devices 1204, network interface devices 1206). Alternatively or additionally, in some embodiments, the server system 1200 includes one or more of: a processing system that includes the processors 1202; a memory or storage system that includes the memory devices 1204; and a network interface system that includes the network interface devices 1206.

The server system 1200 may be arranged, in various embodiments, in many different ways. As just one example, the server system 1200 may be arranged such that the processors 1202 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the server system 1200 may be arranged such that: the processors 1202 include two, three, four, five, or more multi-core processors; the network interface devices 1206 include a first network interface device that implements Ethernet and a second network interface device that implements WiFi and/or Bluetooth; and the memory devices 1204 include a RAM and a flash memory or hard disk.

As previously noted, whenever it is described in this document that a software module or software process performs any action, the action is in actuality performed by underlying hardware elements according to the instructions that comprise the software module. Consistent with the foregoing, in various embodiments, each or any combination of the client device 210 or the server system 200, each of which will be referred to individually for clarity as a “component” for the remainder of this paragraph, are implemented using an example of the client device 1210 or the server system 1200 of FIG. 7. In such embodiments, the following applies for each component: (a) the elements of the client device 1210 shown in FIG. 7 (i.e., the one or more processors 1212, one or more memory devices 1214, one or more network interface devices 1216, one or more display interfaces 1218, and one or more user input adapters 1220) and the elements of the server system 1200 (i.e., the one or more processors 1202, one or more memory devices 1204, one or more network interface devices 1206), or appropriate combinations or subsets of the foregoing, are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the respective memory devices (e.g., in various embodiments, in a volatile memory device such as a RAM or an instruction register and/or in a non-volatile memory device such as a flash memory or hard disk) and all actions described herein as performed by the software modules are performed by the respective processors in conjunction with, as appropriate, the other elements in and/or connected to the client device 1210 or server system 1200; (c) alternatively or additionally, to the extent it is described herein that the component processes and/or otherwise handles data, in some embodiments, such data is stored in the respective memory devices (e.g., in some embodiments, in a volatile memory device such as a RAM and/or in a non-volatile memory device such as a flash memory or hard disk) and/or is processed/handled by the respective processors in conjunction, as appropriate, the other elements in and/or connected to the client device 1210 or server system 1200; (d) alternatively or additionally, in some embodiments, the respective memory devices store instructions that, when executed by the respective processors, cause the processors to perform, in conjunction with, as appropriate, the other elements in and/or connected to the client device 1210 or server system 1200, each or any combination of actions described herein as performed by the component and/or by any software modules described herein as included within the component.

The hardware configurations shown in FIG. 7 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 7, (e) via other hardware arrangements, architectures, and configurations, and/or via combinations of the technology described in (a) through (e).

### Technical Advantages of Described Subject Matter

The technology described herein allows for efficient storage and processing of order data and improves the system's ability to display information and interact with a user. In particular, the system can process large volumes of order data elements and efficiently store the same in a database managed by the system so that the data can be used to generate the user interface. In doing so, the system efficiently stores, organizes, and manages large volumes of data by breaking the data down into understandable components that are used in fast and efficient generation of a display presenting the data.

The resultant user interface generated by the system thus provides information in an easy-to-view manner. In particular, the user interface provides a graphical display of order data showing information related to performance of one or more participants for one or more tradeable instruments. The user interface allows the user to manipulate the display by selecting certain elements in order to change views that are displayed by the user interface. The graphical user interface thus presents the order data in a manner that is significantly easier to understand and access than viewing the order data itself. Moreover, the graphical user interface provides a specific manner for displaying order information resulting in an improved user interface. Thus, the technology also provides improvements in the technical area of software user interfaces and generates an interface that improves the system's ability to interact with the user.

### Selected Definitions

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### Further Applications of Described Subject Matter

Although a number of references are made in this document to web applications, it should be understood that the features described herein may also be used, in various embodiments, in the context of other types of applications such as applications that are deployed/installed as binaries on client systems.

Although a number of references are made in this document to the “securities” and “security instruments,” it should be understood that the features described herein may be used with respect to any type of asset or instrument that can be traded in any kind of market, including without limitation different types of securities (equities, derivatives, options, etc.), futures, fiat currencies, and crypto-assets (including cryptocurrencies and tokens).

Although process steps, algorithms or the like, including without limitation with reference to FIGS. 1-7, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A system configured to generate a user interface for comparing order data from multiple different participants, comprising:
a back end server having at least one memory and at least one processor operatively coupled to the memory, the back end server configured to:
obtain trade order data indicative of a plurality of trades processed for a first tradeable instrument of a plurality of different tradeable instruments, wherein trade order data for each one of the plurality of trades is associated with at least one corresponding participant identifier out of a plurality of participant identifiers that each correspond to a participant in a processed trade;
determine, from trade order data associated with trades for the plurality of the participants for the first tradeable instrument, a market volume weighted average price for the first tradable instrument;
select a group of participant identifiers from among the plurality of participant identifiers and for each corresponding participant identifier:
determine, based on trade order data that is associated with the corresponding participant identifier, a buy volume weighted average price for the first tradeable instrument for the corresponding participant identifier,
determine, based on trade order data that is associated with the corresponding participant identifier, a sell volume weighted average price for the first tradeable instrument for the corresponding participant identifier,
compare the determined buy volume weighted average price and the sell volume weighted average price to the market volume weighted average price, and
determine a performance value for the tradeable instrument for the corresponding participant identifier based on how the buy volume weighted average price and the sell volume weighted average price compared to the market volume weighted average price; and
generate user interface data for displaying a user interface associated with the performance value; and
a client device having at least one memory and at least one processor, the client device configured to communicate with the back end server using communication circuitry, the client device further configured to:
generate, for display, the user interface that includes a graph for displaying the determined performance values for a group of participants that correspond to the selected group of participant identifiers, wherein each one of the group of participants is associated with multiple determined performance values that are associated with respective time periods for the first tradeable instrument; and
plot, to the graph, the determined performance values for each respective time period for each one in the group of participant identifiers to concurrently display multiple plots of the determined performance values over the graph for corresponding participants.

2. The system of claim 1, wherein
comparison of the determined buy volume weighted average price to the market volume weighted average price includes subtracting the buy volume weighted average price from the market volume weighted average price for the first tradeable instrument to determine a buy performance value; and
comparison of the determined sell volume weighted average price to the market volume weighted average price includes subtracting the market volume weighted average price from the sell volume weighted average price to determine a sell performance value.

3. The system of claim 2, wherein determination of the performance value includes adding the buy performance value and the sell performance value.

4. The system of claim 1, wherein the back end server is further configured to:
calculate a buy amount for the first tradeable instrument for each corresponding participant identifier;
calculate a sell amount for the first tradeable instrument for each corresponding participant identifier; and
calculate a churn amount for each corresponding participant identifier based on a ratio between the calculated buy amount and calculated sell amount for the corresponding participant identifier.

5. The system of claim 1, wherein the graph includes the respective time periods plotted along a first axis and the performance value plotted against a second axis.

6. The system of claim 5, wherein each point in the graph is indicative of a performance value on a specific date or time, and a size of the point is based on a number of alerts for the corresponding participant identifier for the specific date across multiple different tradeable instruments.

7. The system of claim 1, wherein the client device is further configured to:
receive a selection based on data displayed as part of the user interface; and
generate a drill down user interface based in response to the selection.

8. A method for generating a user interface, comprising:
at an information processing system having at least a processor and a memory:
communicating with a server to receive user interface data for displaying a user interface associated with a performance value that has been calculated for a selected group of participant identifiers, each performance value being determined for a tradeable instrument for a corresponding participant identifier based on comparison between a market volume weighted average price, a buy volume weighted average price, and a sell volume weighted average price;
generating, for display, the user interface that includes a graph for displaying the determined performance values for a group of participants that correspond to the selected group of participant identifiers, wherein each one of the group of participants is associated with determined performance values that are associated with respective time periods for the first tradeable instrument; and
plot, to the graph, the determined performance values for each respective time period for each one in the group of participant identifiers to concurrently display multiple plots of the determined performance values over the graph for corresponding participants.

9. The method of claim 8, wherein the graph includes a date value along a first axis and the performance value along a second axis.

10. The method of claim 9, wherein each point in the graph is indicative of a performance value on a specific date, and a size of the point is based on a number of alerts for the corresponding participant identifier for the specific date across multiple different tradeable instruments.

11. The method of claim 8, further comprising:
receiving input from a user;
generating a drill down view based on the received input.

12. The method of claim 8, wherein the user interface includes one or more tables related to performance values.

13. The method of claim 8, further comprising generating and displaying an overlay window that provides specific details associated with a selected performance value on a specific date.

14. A computer system, comprising:
a processor; and
a memory storing computer readable instructions that, when executed by the processor, cause the computer system to:
obtain trade order data indicative of a plurality of trades processed for a first tradeable instrument of a plurality of different tradeable instruments, wherein trade order data for each one of the plurality of trades is associated with at least one corresponding participant identifier out of a plurality of participant identifiers that each correspond to a participant in a processed trade;
determine, from trade order data associated with trades for the plurality of the participants for the first tradeable instrument, a market volume weighted average price for the first tradable instrument;
select a group of participant identifiers from among the plurality of participant identifiers and for each corresponding participant identifier:
determine, based on trade order data that is associated with the corresponding participant identifier, a buy volume weighted average price for the first tradeable instrument for the corresponding participant identifier,
determine, based on trade order data that is associated with the corresponding participant identifier, a sell volume weighted average price for the first tradeable instrument for the corresponding participant identifier,
compare the determined buy volume weighted average price and the sell volume weighted average price to the market volume weighted average price, and
determine a performance value for the tradeable instrument for the corresponding participant identifier based on how the buy volume weighted average price and the sell volume weighted average price compared to the market volume weighted average price; and
generate user interface data for displaying a user interface associated with the performance value.

15. The computer system of claim 14, wherein:
comparison of the determined buy volume weighted average price to the market volume weighted average price includes subtracting the buy volume weighted average price from the market volume weighted average price for the first tradeable instrument to determine a buy performance value; and
comparison of the determined sell volume weighted average price to the market volume weighted average price includes subtracting the market volume weighted average price from the sell volume weighted average price to determine a sell performance value.

16. The computer system of claim 15, wherein determination of the performance value includes adding the buy performance value and the sell performance value.

17. The computer system of claim 14, wherein the server is further configured to:
calculate a buy amount for the first tradeable instrument for each corresponding participant identifier;
calculate a sell amount for the first tradeable instrument for each corresponding participant identifier; and
calculate a churn amount for each corresponding participant identifier based on a ratio between the calculated buy amount and calculated sell amount for the corresponding participant identifier.

18. The computer system of claim 14, further configured to:
generate, for display, the user interface that includes a graph for displaying the determined performance values for a group of participants that correspond to the selected group of participant identifiers, wherein each one of the group of participants is associated with multiple determined performance values that are associated with respective time periods for the first tradeable instrument; and
plot, to the graph, the determined performance values for each respective time period for each one in the group of participant identifiers to concurrently display multiple plots of the determined performance values over the graph for corresponding participants
wherein the respective time periods are to be plotted along a first axis of the graph and the performance values are to be plotted against a second axis of the graph.

19. The computer system of claim 18, wherein each point in the graph is indicative of a performance value on a specific date or time, and a size of the point is based on a number of alerts for the corresponding participant identifier for the specific date across multiple different tradeable instruments.

20. The computer system of claim 18, further configured to:
receive a selection based on data displayed as part of the user interface; and
generate a drill down user interface based in response to the selection.
